(19) United States
(12) Patent Application Publication
(10) Pub. No.: US 2010/0173255 A1
(43) Pub. Date: Jul. 8, 2010

(54) NOx-REDUCTION APPARATUS, METHOD OF MAKING, FURNACE, HVAC UNIT, AND BUILDING

(75) Inventors: Allan J. Reifel, Florissant, MO (US); Russell W. Hoeffken, Millstadt, IL (US)

Correspondence Address: BRYAN CAVE LLP, TWO NORTH CENTRAL AVENUE, SUITE 2200, PHOENIX, AZ, 85004, US

(73) Assignee: NORDYNE Inc., O'Fallon, MO (US)

(21) Appl. No.: 12/648,957

(22) Filed: Dec. 29, 2009

Related U.S. Application Data
(60) Provisional application No. 61/142,554, filed on Jan. 5, 2009.

(51) Int. Cl. F23M 9/06; F23M 9/08; F23D 14/70; B21D 53/02; B23P 11/00

(52) U.S. Cl. 431/350; 431/354; 29/890.03; 29/428

(57) ABSTRACT

NOx reduction apparatuses for use in heat exchangers or furnaces, HVAC units and buildings having such devices, and methods of making such devices. Wire embodiments may have a body, helix, or modified helix, and support members that extend outside the body to hold the body away from the heat exchanger or tube. The support members may be made of the wire, and may include bights, twisted bights, or larger (e.g., helical) turns, for instance, between groups of smaller helical turns. In some embodiments, a modified helix is formed by alternating bends and straight sections of wire. Some embodiments include an attachment mechanism that may be made from the wire and may include a hook. Wire may be Nichrome. Particular embodiments may allow burning of natural gas or LP without changing or removing the wire.

### RELATED PATENT APPLICATIONS

This patent application claims priority to U.S. Provisional Patent Application No. 61/142,554, filed on Jan. 5, 2009, having the same title and inventors, the contents of which are incorporated herein by reference.

### FIELD OF THE INVENTION

This Invention relates to apparatuses and systems for reducing pollution and to HVAC units and furnaces, as well as HVAC systems and buildings containing such equipment, and methods of making such apparatuses. Particular embodiments concern devices that reduce NOx emissions when placed in heat exchanger tubes where combustion takes place.

### BACKGROUND OF THE INVENTION

Various fuels have been burned for some time to produce heat for various purposes including heating spaces that people occupy, such as within buildings, vehicles, or the like. Combustion of fuels has produced various pollutants that have been released into the atmosphere, and alterations have been made to equipment to reduce the quantity of certain pollutants that have been emitted.

In a specific example, a number of different fuels have been burned within heat exchanger tubes in furnaces and various solid devices have been placed within the heat exchanger tubes that have reduced the production of oxides of Nitrogen (NOx) during the combustion process. Such solid devices or baffles have accomplished a reduction in NOx emissions and have performed satisfactorily when natural gas has been burned in the furnace.

Examples of NOx-reduction devices or baffles are described in U.S. Pat. Nos. 5,146,910, 5,472,339, 5,546,925, 5,649,529, 5,730,116, and 6,485,294, for instance. FIGS. 2 and 3 also illustrates another example of a prior art NOx-reduction device, device 30, that consists of a helically would wire 34 surrounding a sheet metal structural support 33. The sheet metal support 33 was necessary in this prior art design to support the helically would wire 34, adding complexity and cost to the device. In the prior art example of FIGS. 2 and 3, the wire 34 and support 33 were both made of stainless steel.

In some installations, liquefied petroleum (LP) gas (or LPG) has been burned in furnaces, and soot has built up on stainless steel NOx-reduction baffles, restricting the heat exchanger tubes. As a result, it has been necessary in the prior art to remove the baffles (e.g., device 30) when such furnaces were used with LP. For LP applications, the baffles (e.g., device 30) have been removed in the field. Installers of such furnaces, however, have not always removed the baffles (e.g., device 30) when such furnace were used with LP, which has resulted in shut down of the furnace, the need for a service call, and subsequent customer dissatisfaction with the furnace. In addition, in various prior art NOx-reduction baffle configurations (e.g., device 30), increased levels of noise were produced, flames were quenched when starting (e.g., when starting a furnace), or both.

Needs or potential for benefit or improvement exist for devices or apparatuses that reduce pollution, such as NOx emissions, from furnaces, for example, but that do not require special installation procedures such as removal or alteration of the device or apparatus (e.g., device 30) when the furnace or unit is used with an alternative fuel, such as LP, for instance. Needs or potential for benefit or improvement also exist for devices or apparatuses that reduce pollution, such as NOx emissions, from furnaces, for example, that are suitable for use in HVAC systems or units, for example that more-effectively reduce pollution (e.g., NOx emissions) that are inexpensive, that can be readily manufactured, that are easy to install, that are reliable, that have a long life, that are light weight, that do not collect soot, that can withstand high temperatures, or a combination thereof, as examples.

Needs or potential for benefit or improvement also exist for devices or apparatuses that reduce pollution, such as NOx emissions, from furnaces, for example, that are quiet and that do not quench the flame when starting. In addition, needs or potential for benefit or improvement exist for furnaces and HVAC units that include such devices or apparatuses that reduce pollution, as well as buildings having such units, systems, devices, or apparatuses.

Further, needs or potential for benefit or improvement exist for methods of manufacturing such furnaces, HVAC units, buildings, systems, devices, and apparatuses. Other needs or potential for benefit or improvement may also be described herein or known in the HVAC or pollution-control industries. Room for improvement exists over the prior art in these and other areas that may be apparent to a person of ordinary skill in the art having studied this document.

### BRIEF DESCRIPTION OF THE DRAWINGS

FIG. 1 is an isometric view of a furnace with certain exterior panels removed to show internal components including a heat exchanger and two fans;

FIG. 2 is an isometric view illustrating a prior art NOx-reduction device installed in a heat exchanger tube;

FIG. 3 is an isometric view illustrating the prior art NOx-reduction device of FIG. 2 that consists of a helically wound wire surrounding a sheet metal structural support;

FIG. 4 is an isometric view of an example of a furnace heat exchanger tube in which combustion takes place, and through which products of combustion pass, that contains an example of an embodiment of a NOx-reduction apparatus that includes turns or loops of varying or differing diameters;

FIG. 5 is a top view of the example embodiment of a NOx-reduction apparatus shown in FIG. 4, which includes larger helical turns that act as supports separated by groups of several smaller helical turns;

FIG. 6 is an isometric view of the example embodiment of a NOx-reduction apparatus shown in FIGS. 4 and 5, which includes larger helical turns separated by several smaller helical turns;

FIG. 7 is a side view of the example embodiment of a NOx-reduction apparatus shown in FIGS. 4-6, which includes larger helical turns and smaller helical turns;

FIG. 8 is an end view of the example embodiment of a NOx-reduction apparatus shown in FIGS. 4-7, which includes larger helical turns and smaller helical turns;

FIG. 9 is an isometric view of an example of a furnace heat exchanger tube in which combustion takes place, and through which products of combustion pass, that contains another example of an embodiment of a NOx-reduction apparatus, this embodiment being similar to the embodiment shown in FIGS. 4-8 except being longer;

FIG. 10 is a top view of the example embodiment of a NOx-reduction apparatus shown in FIG. 9, which includes larger helical turns that act as supports separated by groups of several smaller helical turns;

FIG. 11 is an isometric view of the example embodiment of a NOx-reduction apparatus shown in FIGS. 9 and 10, which includes larger helical turns separated by several smaller helical turns;

FIG. 12 is a side view of the example embodiment of a NOx-reduction apparatus shown in FIGS. 9-11, which includes larger helical turns and smaller helical turns (an end view of the example embodiment of a NOx-reduction apparatus shown in FIGS. 9-12 would be similar to FIG. 8);

FIG. 13 is an isometric view of an example of a furnace heat exchanger tube in which combustion takes place, and through which products of combustion pass, that contains yet another example of an embodiment of a NOx-reduction apparatus, this embodiment having multiple support members that extend outside of a helix to hold the helix away from the heat exchanger tube;

FIG. 14 is an isometric view of the example embodiment of a NOx-reduction apparatus shown in FIG. 13, which includes support members that are formed by bights in the wire;

FIG. 15 is a side view of the example embodiment of a NOx-reduction apparatus shown in FIGS. 13 and 14;

FIG. 16 is an end view of the example embodiment of a NOx-reduction apparatus shown in FIGS. 13-15;

FIG. 17 is an isometric view of an example of a furnace heat exchanger tube in which combustion takes place, and through which products of combustion pass, that contains still another example of an embodiment of a NOx-reduction apparatus, this embodiment also having multiple support members that extend outside of a helix to hold the helix away from the heat exchanger tube;

FIG. 18 is an end view of the example embodiment of a NOx-reduction apparatus shown in FIG. 17, wherein the support members include twists in the wire;

FIG. 19 is an isometric view of the example embodiment of a NOx-reduction apparatus shown in FIGS. 17 and 18, which includes support members that include twists in the wire;

FIG. 20 is a partial isometric view taken between a side view and a top view of the example embodiment of a NOx-reduction apparatus shown in FIGS. 17-19;

FIG. 21 is an isometric view of an example of a furnace heat exchanger tube in which combustion takes place, and through which products of combustion pass, that contains yet another example of an embodiment of a NOx-reduction apparatus, this embodiment having a body that is shaped to form a modified helix that includes multiple bends separated by straight sections, each bend being slightly less than 180 degrees;

FIG. 22 is an end view of the example embodiment of a NOx-reduction apparatus shown in FIG. 21;

FIG. 23 is an end view of a small portion of the example embodiment of a NOx-reduction apparatus shown in FIGS. 21 and 22, illustrating in more detail the arrangement of the bends and straight sections of wire;

FIG. 24 is an isometric view of the example embodiment of a NOx-reduction apparatus shown in FIGS. 21-23, which has a body that is shaped to form a modified helix that includes multiple bends separated by straight sections, each bend being slightly less than 180 degrees;

FIG. 25 is a side view of the example embodiment of a NOx-reduction apparatus shown in FIGS. 21-24;

FIG. 26 is an isometric view of a building having an HVAC unit, which includes an air conditioning and a furnace (e.g., similar to or as shown in FIG. 1) which may include therein a heat exchanger and a NOx-reduction apparatus (e.g., similar to or as shown in FIGS. 4-25); and

FIG. 27 is a flow chart illustrating an example of a method of making and implementing a NOX reduction apparatus.

The drawings illustrate, among other things, various examples of embodiments of the invention, and certain examples of characteristics thereof. Different embodiments of the invention include various combinations of elements or acts shown in the drawings, described herein, known in the art, or a combination thereof, for instance.

### SUMMARY OF PARTICULAR EMBODIMENTS OF THE INVENTION

This invention provides, among other things, NOx-reduction apparatuses and methods of making or implementing such apparatuses, as well as furnaces, HVAC units, HVAC systems, and buildings having such NOx-reduction apparatuses, as examples. A number of embodiments of NOx-reducing apparatuses include or are made of wire, which may be wound into a helix or into a modified helix, for example. Some embodiments have support members, for example, extending outside of the helix to hold the helix away from the heat exchanger (e.g., from the inside surface or wall, for instance, of a tube), for instance, which may form a particular modified helix. Other embodiments may include a modified helix that includes alternating bends and straight sections, as another example.

Various embodiments provide, for example, as an object or benefit, that they partially or fully address or satisfy one or more of the needs, potential areas for benefit, or opportunities for improvement described herein, or known in the art, as examples. Certain embodiments provide, for example, devices or apparatuses that reduce pollution, such as NOx emissions, from furnaces, for example. Some embodiments specifically do not require special installation procedures such as removal or alteration of the device or apparatus when the furnace or unit is used with an alternative fuel, such as LP, for instance. Particular embodiments provide devices or apparatuses that reduce pollution, such as NOx emissions, from furnaces, for example, that are suitable for use in HVAC systems or units, for instance, that more-effectively reduce pollution (e.g., NOx emissions), that are inexpensive, that can be readily manufactured, that are easy to install, that are reliable, that have a long life, that are light weight, that do not collect soot, that can withstand high temperatures, that are quiet, that do not quench the flame upon starting, or a combination thereof, as examples.

In addition, particular embodiments provide, as objects or benefits, for instance, furnaces or HVAC units that include such devices or apparatuses that reduce pollution, or buildings having such units, systems, devices, or apparatuses, as further examples. Further, some embodiments provide methods of manufacturing such furnaces, HVAC units, buildings, systems, devices, or apparatuses, as examples. In addition, various other embodiments of the invention are also described herein, and other benefits of certain embodiments may be apparent to a person of ordinary skill in the art.

Specific embodiments of the invention include an apparatus for reducing NOx production in a heat exchanger in which combustion takes place and through which products of combustion pass. In various embodiments, the apparatus may include, for instance, a wire formed into a helix having a helix diameter, and multiple support members extending outside of the helix diameter to hold the helix away from the heat exchanger. In certain embodiments, the support members may have a support member diameter and the support member diameter may be substantially larger than the helix diameter, the support members may be helical, or both, as examples. In a number of embodiments the support members may include the wire, or may even consist entirely of the wire, as examples. In various embodiments, the support members may include bights in the wire, twists in the wire, loops in the wire, or a combination thereof, for instance. In particular embodiments, the support members may be spaced at multiple locations around the helix, for example, at locations substantially equally spaced around the helix.

Further, in different embodiments, the helix may have a varying helix diameter along the helix, or may have a substantially uniform helix diameter along the helix, as examples. In a number of embodiments, apparatuses may include an attachment member, for example, extending from the helix for attaching the apparatus. In various embodiments, the attachment member may include the wire, or may even consist entirely of the wire, as examples. Moreover, in certain embodiments, the wire may be Nichrome wire, the support members may be sized and configured to hold the helix substantially concentric with a heat exchanger tube, the helix may have an interior volume that is empty, or a combination thereof, as examples. Still other embodiments include a furnace that includes such an apparatus, or a building that includes such a furnace, as other examples.

Other embodiments of the invention include an apparatus for reducing NOx production in a heat exchanger that includes a wire formed into a modified helix having smaller helical turns and larger turns, and the larger turns may be spaced between groups of smaller helical turns such that the larger turns substantially center the smaller helical turns in at least a portion of the heat exchanger when the apparatus is installed therein. The smaller helical turns and the larger turns may have a common centerline, for example. In particular embodiments the wire may include Nichrome, for example.

Other embodiments of the invention include a furnace that includes multiple of the apparatus for reducing NOx production. In these embodiments, the furnace may include a heat exchanger that has multiple heat exchanger tubes in which combustion takes place and through which products of combustion pass, and each heat exchanger tube may contain at least one of the apparatus for reducing NOx production, for instance. In a number of embodiments, for each apparatus and for each heat exchanger tube, for example, the larger turns substantially center the smaller helical turns in the heat exchanger tube when the apparatus is installed in the heat exchanger tube. Other embodiments include an HVAC unit that includes such a furnace as well as an air conditioning system, as another example.

Still other specific embodiments of the invention include, for example, a furnace that includes, for instance, at least one heat exchanger in which combustion takes place and through which products of combustion pass, and a NOx-reducing apparatus within the heat exchanger. In particular embodiments, the apparatus includes, for instance, an elongated wire having a length, and the wire may be shaped to form a modified helix, and may include, for example, multiple bends along the length of the wire, each bend having a substantially identical radius and having a substantially identical angle. In a number of embodiments, the angle of each bend in the wire may be less than 180 degrees, for example, and adjacent bends along the length of the wire may be separated by straight sections of the wire. In certain embodiments, each straight section may have a substantially identical dimension along the length of the wire, for instance.

Yet other embodiments of the invention include a method, for example, of making a NOx-reducing apparatus for use in a heat exchanger in which combustion takes place and through which products of combustion pass. Such a method may include, for instance, at least the acts of obtaining wire, winding the wire, and cutting the wire. Further, the wire may be wound to form a modified helix having smaller helical turns and larger turns, and the larger turns may be spaced between groups of smaller helical turns. In a number of embodiments, the smaller helical turns and the larger turns may have a substantially common centerline, for example. Some embodiments may also include, for instance, an act of installing the wire in the heat exchanger.

Moreover, a number of methods may further include an act of instructing a furnace installer that a furnace that includes the wire can burn natural gas, and also instructing the furnace installer that the furnace that includes the wire can burn LP gas, without instructing the furnace installer to omit the wire for use with LP gas, for example. Furthermore, a number of such embodiments may further include an act of advertising that an apparatus that includes the wire can burn natural gas and that an apparatus that includes the wire can burn LP gas, as another example. In addition, various other embodiments of the invention are also described herein.

### DETAILED DESCRIPTION OF EXAMPLES OF EMBODIMENTS

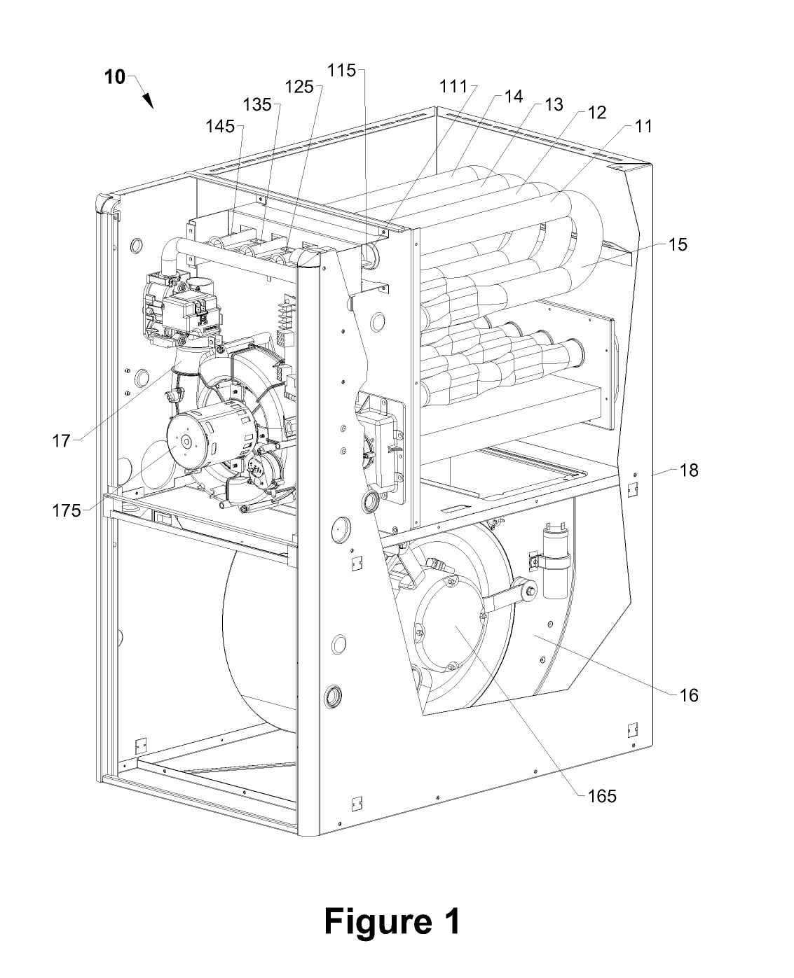

FIG. 1 illustrates furnace 10, which includes housing 18, heat exchanger 15, indoor air fan 16, and combustion air fan 17, among other things. In this embodiment, indoor air fan 16 is driven by electric motor 165, and combustion air fan 17 is driven by electric motor 175. Further, in this particular embodiment, heat exchanger 15 includes heat exchanger tubes 11, 12, 13, and 14, each fed by a burner. Specifically, burner 115 feeds heat exchanger tube 11, burner 125 feeds heat exchanger tube 12, burner 135 feeds heat exchanger tube 13, and burner 145 feeds heat exchanger tube 14. Fan 17 draws air from outside of housing 18 through heat exchanger 15. Burners 115, 125, 135, and 145 introduce fuel into heat exchanger tubes 11, 12, 13, and 14, and the fuel is ignited proximate to burners 115, 125, 135, and 145 so that the fuel burns within heat exchanger tubes 11, 12, 13, and 14. At the same time, indoor air from fan 16 passes through heat exchanger 15, external to heat exchanger tubes 11, 12, 13, and 14 of heat exchanger 15, and is heated. Other embodiments may have a different type of heat exchanger, such as a clamshell heat exchanger, for example. Some embodiments may include a serpentine clamshell heat exchanger, for instance.

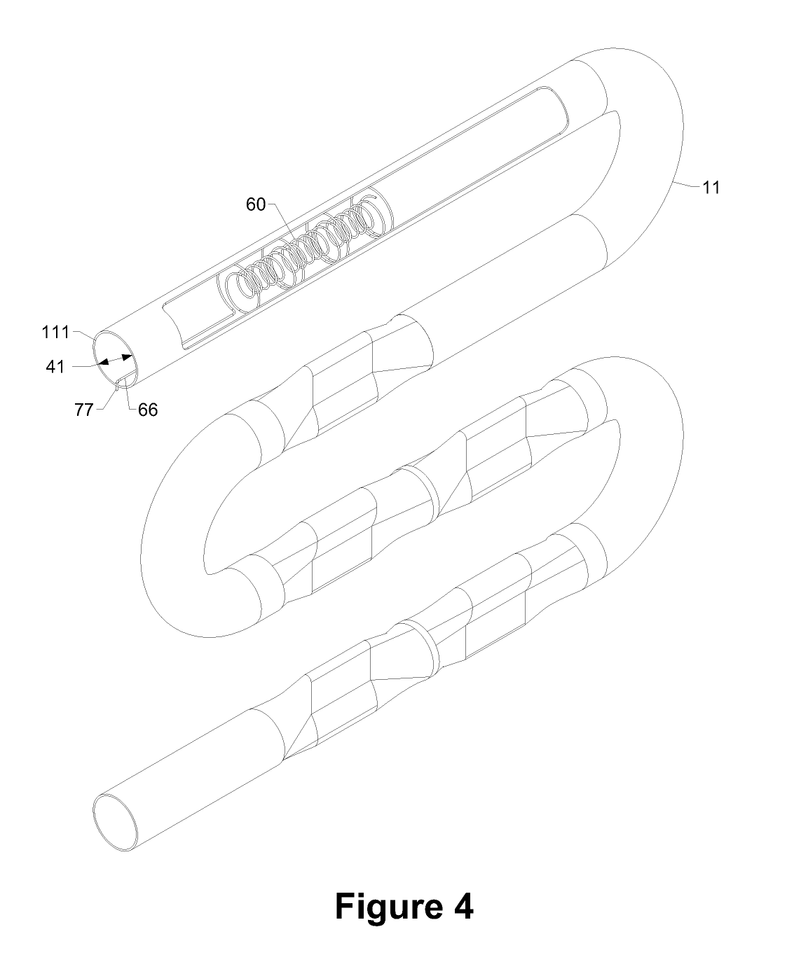

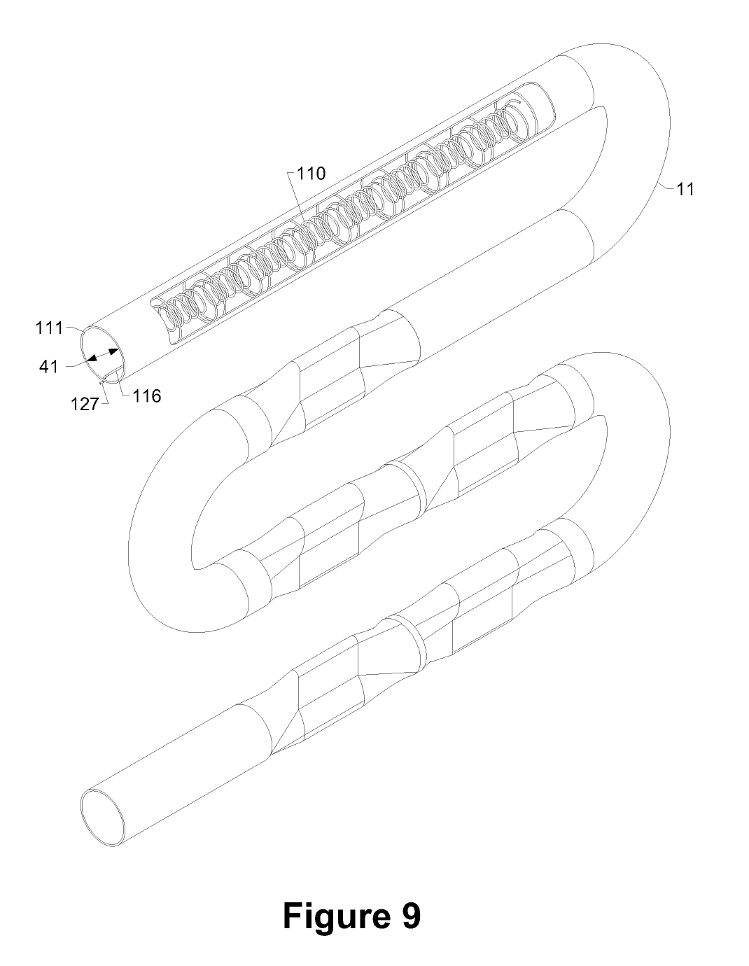

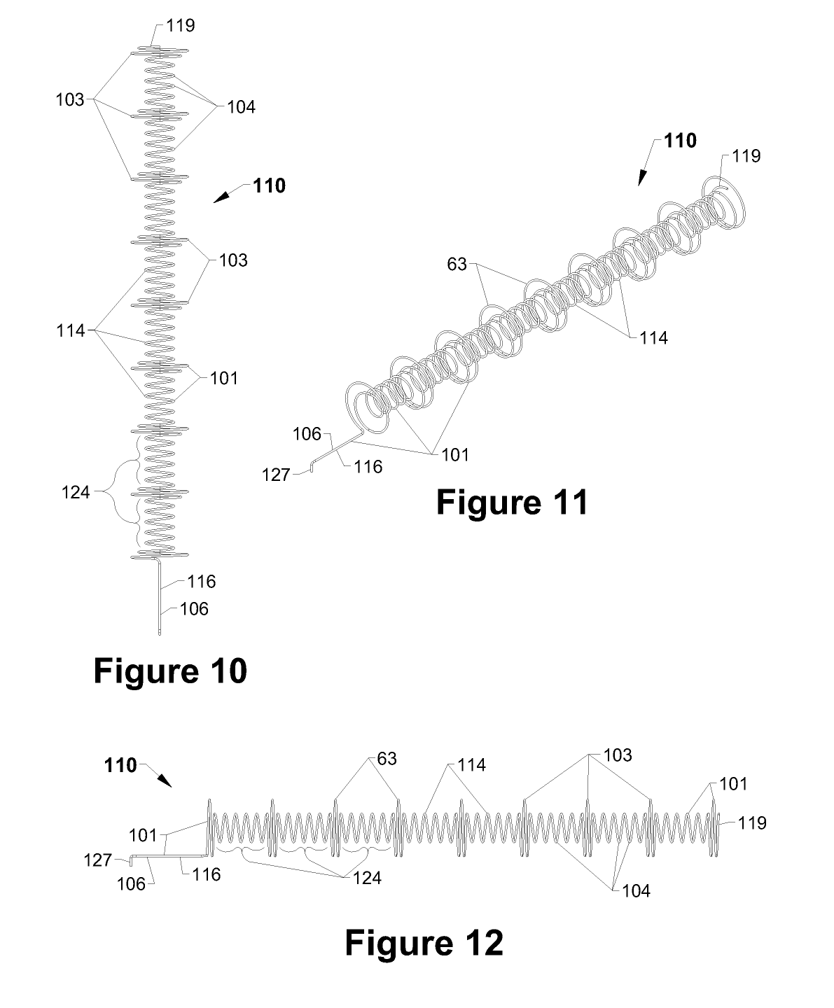

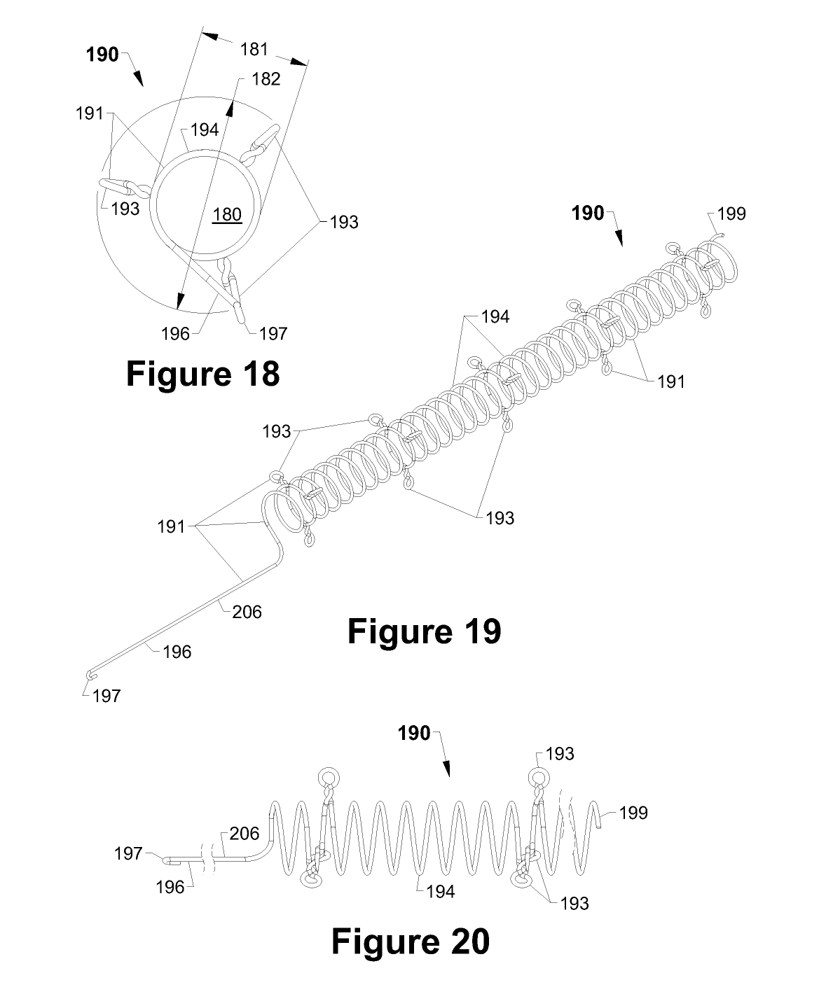

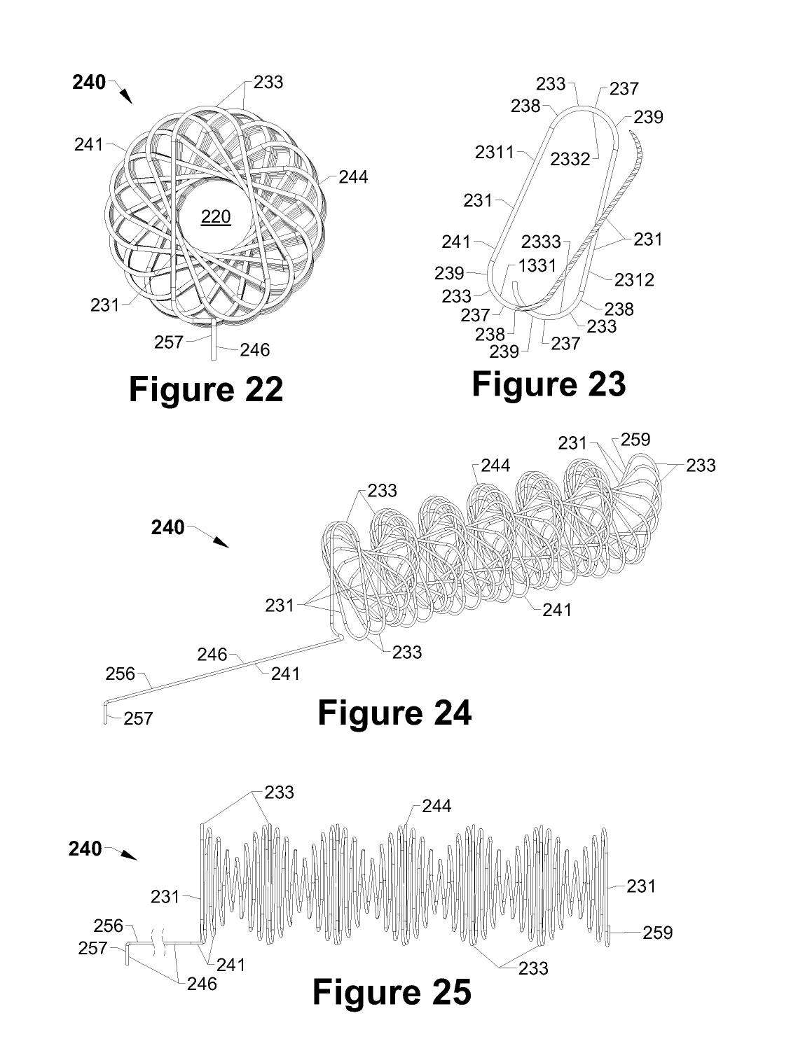

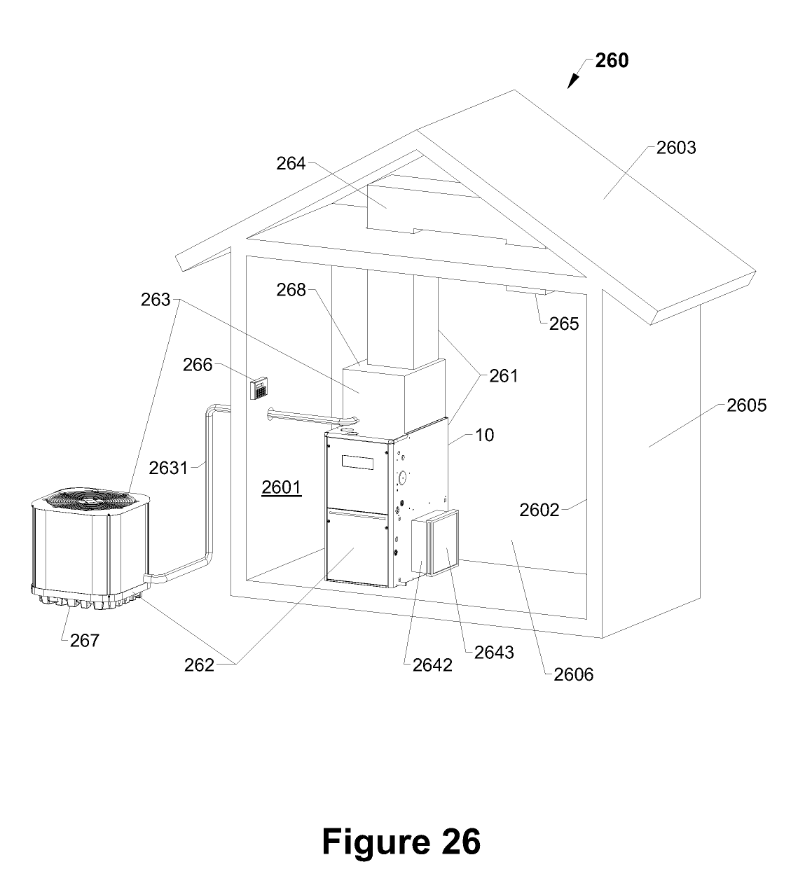

Although not shown in FIG. 1, in various embodiments, heat exchanger 15 or heat exchanger tubes 11, 12, 13, and 14 may each contain an apparatus for reducing NOx production, various examples of which are described herein. Particular embodiments 60, 110, 140, 190, and 240 of NOx reduction apparatuses are shown, as examples, in FIGS. 4-25. FIG. 26 illustrates building 260, which includes heating, ventilating, and air conditioning (HVAC) system 261. HVAC system 261, in this embodiment, includes HVAC unit 262, ductwork 264, register 265, and thermostat 266, as examples. Further, in this embodiment, HVAC unit 262 includes furnace 10 and air conditioning unit 263. In the embodiment illustrated, air conditioning unit 263 is a split system unit including an outdoor unit 267 containing a compressor, condenser, and condenser fan, and an indoor unit 268 containing an evaporator, as examples.

Specific embodiments 60, 110, 140, 190, and 240 of NOx reduction apparatuses shown in FIGS. 4-25 are examples of devices for reducing pollution which may be included in various furnaces (e.g., 10), HVAC units (e.g., 262), HVAC systems (e.g., 261), buildings (e.g., 260), vehicles, and methods, for instance, of manufacturing devices for reducing pollution, NOx-reduction apparatuses, furnaces, HVAC units, HVAC systems, buildings (e.g., 260), and vehicles, for example. As used herein “HVAC units” include air conditioning units and heat pumps, for example, direct expansion units. Further, as used herein “HVAC units” include furnaces (e.g., 10), for example, condensing furnaces, and units that include both air conditioning and a furnace (e.g., unit 262), for another example. Various embodiments include improvements over prior technology that reduce pollution production, such as NOx emissions, for instance. Various embodiments include a means for reducing pollution production or specifically a means for reducing NOx emissions, as examples.

Certain embodiments include a building (e.g., 260) that includes an HVAC unit (e.g., 262), HVAC system (e.g., 261), air conditioning unit (e.g., 263), furnace (e.g., 10), or an apparatus or device (e.g., for reducing NOx emissions, for instance, embodiments 60, 110, 140, 190, and 240) described herein, or an HVAC unit, HVAC system, or air conditioning unit, having an apparatus described herein, as examples. Such a building (e.g., 260) may include walls (e.g., 2601 and 2602) and a roof (e.g., 2603), and may form an enclosure (e.g., 2605) or enclose an occupied space (e.g., 2606), for example. A building (e.g., 260) or HVAC system (e.g., 261) may include, besides an HVAC unit (e.g., 262), supply (e.g., 264) and return (e.g., 2642) air ductwork, registers (e.g., 265), an air filter (e.g., 2643), a thermostat or controller (e.g., 266), and a condensation drain, or a combination thereof, for example. HVAC units (e.g., 262) may include a compressor, an evaporator fan (e.g., 16), a condenser fan, motors for the compressor and fans (e.g., 165 for fan 16), a housing (e.g., 18), wiring, controls (e.g., thermostat 266), refrigerant tubing (e.g., 2631), an expansion valve, and the like, for instance. In different embodiments, HVAC units may be packaged units or may be spit systems (e.g., 262), as examples.

Certain embodiments are, or include, an apparatus for reducing NOx production in a burner tube, a heat exchanger, (e.g., 15) or a heat exchanger tube (e.g., 11, 12, 13, 14, or a combination thereof) in which combustion takes place and through which products of combustion pass, for instance. In a number of embodiments, the heat exchanger (e.g., 15) or heat exchanger tube (e.g., 11, 12, 13, or 14) may be round or circular (e.g., in cross section) and may have an inside dimension, such as an inside diameter (e.g., 41 shown in FIGS. 4, 9, 13, 17, and 21), for example. In various embodiments, a solid material may be disposed within the flame, for instance. In some embodiments, the solid material or apparatus may be limited to the flame area, may be locate at or near the beginning of the flame (e.g., close to the burner 115, 125, 135, or 145), or both. This solid material may enhance the quality of combustion, and may reduce the formation of pollutants (e.g., NOx), increase he amount of energy produced by the combustion process, or both, as examples.

Referring to FIGS. 4-20, in some embodiments, the apparatus (e.g., embodiments 60, 110, 140, and 190) may include, for instance, a wire (e.g., 61, 101, 141, or 191), which may be formed into a helix (e.g., 64, 114, 144, or 194) having a helix diameter (e.g., 81, 161, or 181), for instance. Some embodiments may also include, for example, multiple support members (e.g., 63, 143, or 193) extending outside of the helix diameter (e.g., 81, 161, or 181), for instance, to hold the helix (e.g., 64, 114, 144, or 194) away from the heat exchanger (e.g., 15) or heat exchanger tube (e.g., 11, 12, 13, 14, or a combination thereof) (e.g., away from the inside surface thereof). In some embodiments, the support members (e.g., 63, 143, 193, or bends or support members 233) may include, or even consist of (i.e., only of), the wire (e.g., 61, 101, 141, 191, or 241), as examples.

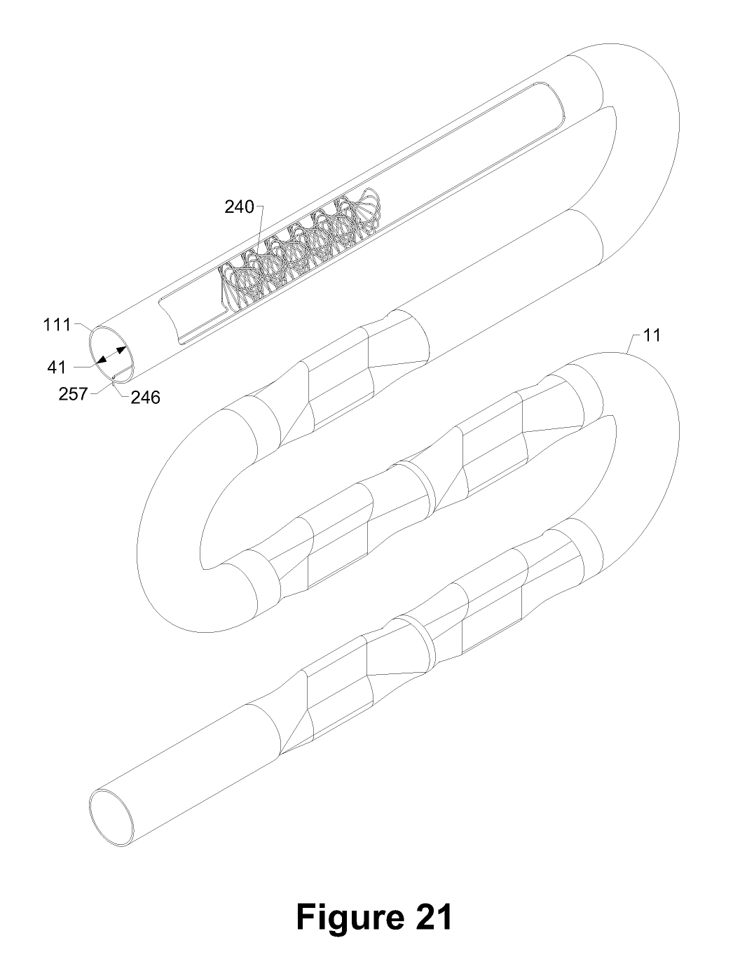

In various embodiments of an apparatus for reducing NOx production in a heat exchanger (e.g., 15) or heat exchanger tube (e.g., 11, 12, 13, or 14) in which combustion takes place and through which products of combustion pass, the apparatus may include a wire (e.g., 61, 101, 141, 191, or 241) formed into a body shape (e.g., a helix or a modified helix) having at least one lateral body dimension (e.g., helix diameter 81, 161, or 181), for example. A helix (e.g., 64, 114, 144, or 194) is an example of such a body shape, and diameter is an example of such a lateral dimension. But other shapes may be used in other embodiments (e.g., modified helix 244 shown in FIGS. 21-25). As used herein, the term “modified helix” includes a helix with other features added, such as support members (e.g., 63, 143, or 193) or straight sections (e.g., 231). A “modified helix”, as used herein, has multiple turns around a centerline that progress in a direction along the centerline. Such turns do not necessarily have to maintain a constant radius of curvature, however. In a number of embodiments the lateral dimension may be perpendicular to the axis of the heat exchanger tube (e.g., 11, 12, 13, 14, or a combination thereof), when the apparatus (e.g., 60, 110, 140, 190, or 240) is installed in the tube, for instance. Different embodiments may have a shape that may be cylindrical, and may have a cross section that is round (e.g., as shown for helix 64, 114, 144, or 194), square, rectangular, triangular, hexagonal, octagonal, helical (e.g., modified helix 244), or the like, as examples. In certain embodiments, such a body may be combined with multiple support members (e.g., 63, 143, or 193), for instance, extending outside of the body dimension (e.g., outside of or beyond the helix diameter), for example, to hold the body shape away from the (e.g., inside of the) heat exchanger (e.g., 15) or heat exchanger tube (e.g., 11, 12, 13, or 14). Again, in some embodiments, the support members (e.g., 63, 143, or 193) may include or even consist of the wire (e.g., 61, 101, 141, 191, or 241).

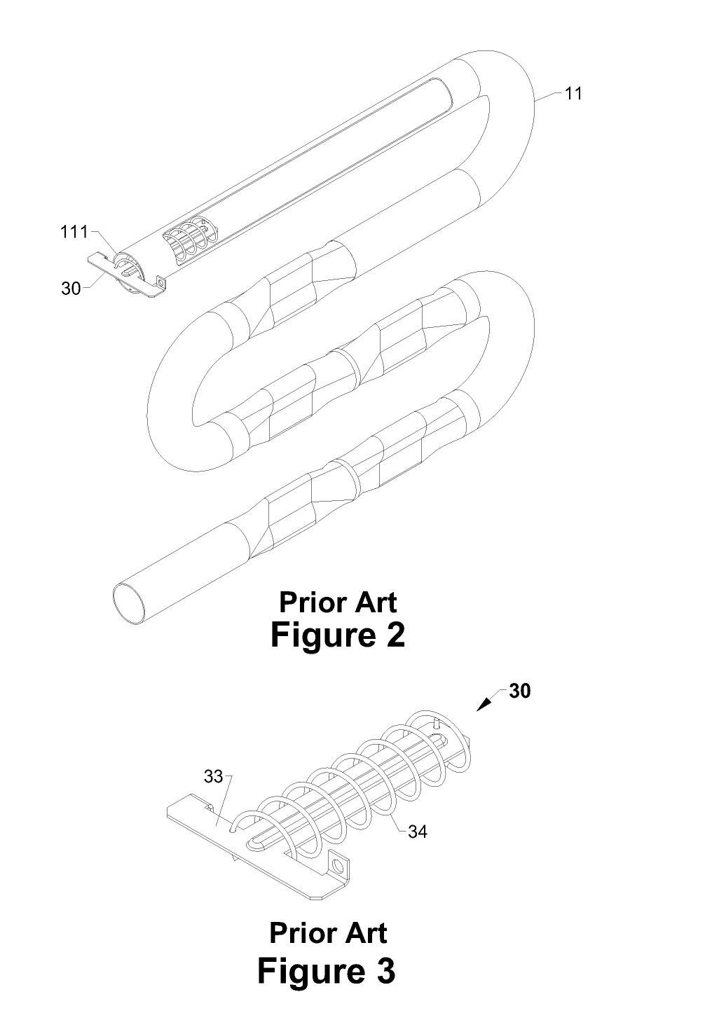

In a number of embodiments, the apparatus (e.g., 60, 110, 140, 190, or 240) may be self-supporting, meaning that it does not need other structure (e.g., besides the apparatus or wire, such as wire 61, 101, 141, 191, or 241, and the heat exchanger (e.g., 15) or heat exchanger tube, for example, 11, 12, 13, or 14) to support the apparatus or wire within the heat exchanger or tube, for instance. In contrast, in the prior art embodiment 30 shown in FIGS. 2 and 3, the wire of helix 34 is not self supporting, but rather is supported by sheet metal support 33. Further, in a number of embodiments, the apparatus (e.g., 60, 110, 140, 190, or 240) may be self-centering, meaning that it does not need other structure (e.g., besides the apparatus or wire) to center or substantially center the apparatus or wire (e.g., 61, 101, 141, 191, or 241) within the heat exchanger or part of the heat exchanger, for instance, heat exchanger tube (e.g., 11, 12, 13, or 14). In contrast, in the prior art embodiment 30 shown in FIGS. 2 and 3, the wire of helix 34 is not self centering, but rather is centered by sheet metal support 33.

In some embodiments, the apparatus (e.g., 60, 110, 140, 190, or 240) may require only the support members (e.g., 63, 143, 193, or 233), an attachment member (e.g., 66, 116, 146, 196, or 246), or both, for example, to support the apparatus within a heat exchanger or tube (e.g., 11, 12, 13, or 14), center or substantially center the apparatus (e.g., 60, 110, 140, 190, or 240) within the heat exchanger tube (e.g., 11, 12, 13, or 14), or both, as examples. Various embodiments may omit or not require sheet metal support members (e.g., 33) within the heat exchanger tube (e.g., 11, 12, 13, 14, or a combination thereof), for example, in contrast to the prior art shown in FIGS. 2 and 3.

In various embodiments, the wire (e.g., 61, 101, 141, 191, or 241) formed into a body shape having at least one lateral body dimension (e.g., apparatus (e.g., 60, 110, 140, 190, or 240) may be combined with an attachment member (e.g., 66, 116, 146, 196, or 246) extending from the body shape (e.g., helix or modified helix) for attaching the apparatus (e.g., 60, 110, 140, 190, or 240), for instance, to the heat exchanger (e.g., 15) or heat exchanger tube (e.g., 11, 12, 13, or 14). In various embodiments, the attachment member (e.g., 66, 116, 146, 196, or 246) may include or consist of the wire (e.g., 61, 101, 141, 191, or 241), as examples. Examples of attachment members (e.g., 66, 116, 146, 196, or 246) are shown in FIGS. 4-22 and 24-25, for instance, which may attach to the entrance end 111 of the heat exchanger (e.g., 15) or heat exchanger tube (e.g., 11, 12, 13, or 14), for example.

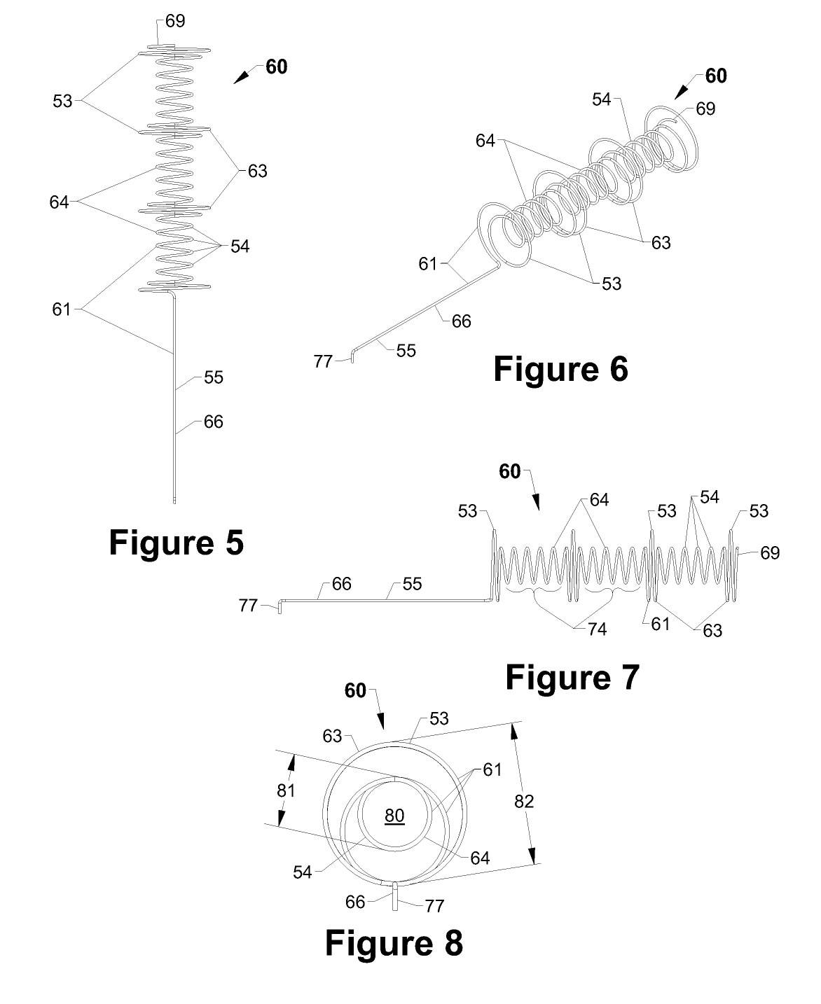

A number of embodiments of an apparatus (e.g., 60, 110, 140, 190, or 240), for instance, for reducing NOx production in a heat exchanger (e.g., 15) or a heat exchanger tube (e.g., 11, 12, 13, or 14, for instance, having an inside diameter 41), may include or consist of a wire (e.g., 61, 101, 141, 191, or 241) formed into a modified helix. FIGS. 4-25 illustrate examples of modified helixes. Some embodiments, such as shown in FIGS. 5-12, for instance, have smaller helical turns (e.g., 54 or 104 of helix 64 or 114) and larger (e.g., helical) turns (e.g., 53 or 103 or support member 63), for example. In some such embodiments, such as the embodiment shown in FIGS. 4-12, the larger turns (e.g., 53 or 103) may be spaced between groups (e.g., 74 or 124) of smaller helical turns (e.g., 54 or 104) such that the larger turns (e.g., 53 or 103) substantially center the smaller (e.g., helical) turns (e.g., 54 or 104) in the heat exchanger or in part of the heat exchanger, such as in a heat exchanger tube (e.g., 11, 12, 13, or 14) when the apparatus (e.g., 60 or 110) is installed in the heat exchanger or heat exchanger tube, for example. As used herein, “substantially center”, when referring to an apparatus (e.g., 60, 110, 140, or 190) within a heat exchanger or tube (e.g., 11, 12, 13, or 14), means centered to within ten (10) percent of the inside diameter (e.g., 41) or equivalent dimension of the heat exchanger or tube (e.g., 11, 12, 13, or 14). In some embodiments, the smaller helical turns (e.g., 54 or 104) and the larger turns (e.g., 53 or 103) have a common centerline, for instance (e.g., the centerline of the heat exchanger tube when installed therein). As used herein, a “common centerline”, when referring to two helixes, means that the best fit centerline for both helixes (e.g., helixes 64 or 114 and helixes formed by support members 63 or larger helical turns 53 or 103) are within a distance from each other, along the lengths of the two helixes, that does not exceed ten (10) percent of the diameter of the larger helix (e.g., of larger helical turns 53 or 103).

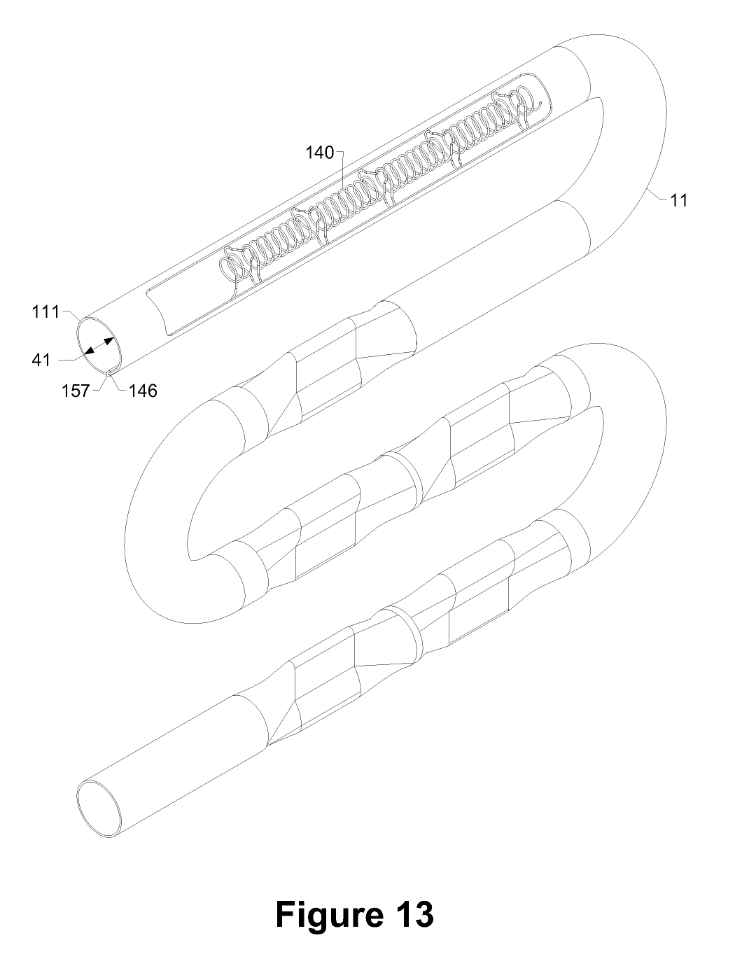

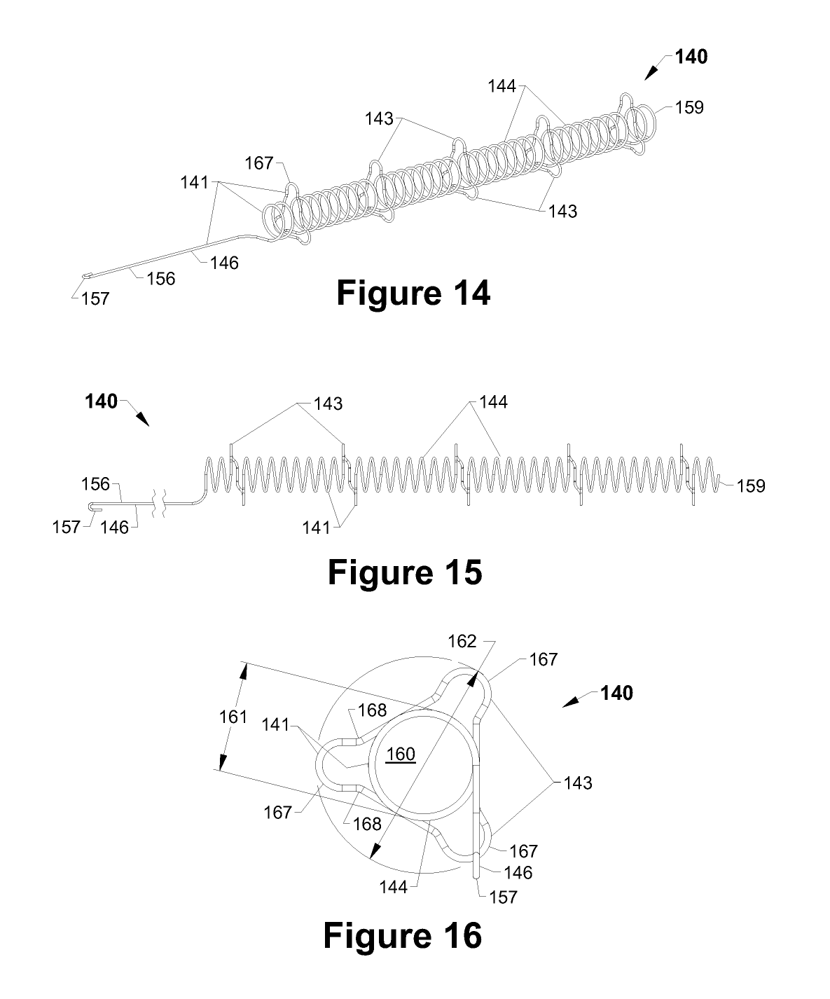

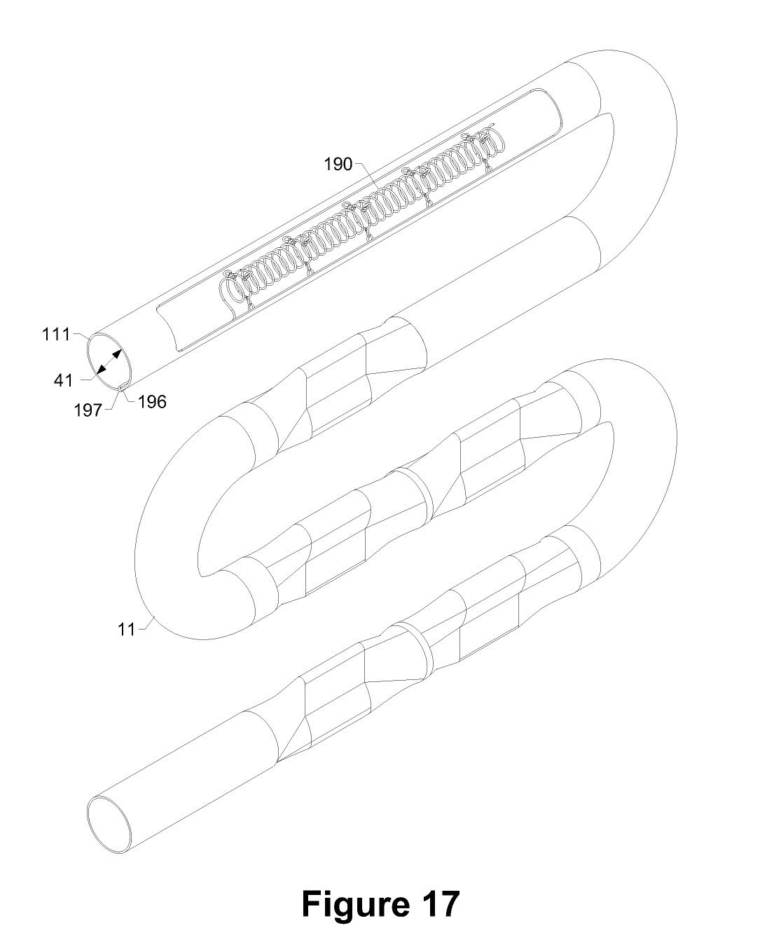

In various embodiments, the support members (e.g., 63, 143, 193, or 233) consist entirely of the wire (e.g., as shown in FIGS. 4-25). In particular embodiments, certain support members (e.g., 193 shown in FIGS. 17-20) include twists in the wire (e.g., twisted loops or two or more strands of wire twisted together). In certain embodiments, support members (e.g., 143 or 193) include bights in the wire (e.g., as shown in FIGS. 13-20). As used herein, a “bight” in the wire is a portion of wire that includes a bend and that protrudes from a body or helix formed by the wire. In some embodiments, a “bight” may include a main bend of about 180 degrees (e.g., main bend 167 as shown in FIGS. 14 and 16. Further, in some embodiments, a “bight” may include a main bend (e.g., 167) that has a smaller radius of curvature than the helix or body, for example. Even further, in some embodiments, (e.g., as shown in FIG. 16) bights may have one or more minor bends (e.g., 168, two of which are shown), which may have a smaller angle of bend than the main bend (e.g., 167), may bend in the opposite direction of the main bend (e.g., 167), or both. Support members 193 shown in FIGS. 17-20 include bights that have been twisted, as another example. Some embodiments may include some support members or bights that are twisted and some that are not twisted, as another example, or may include another combination of support members (e.g., 63, 143, 193, or 233), as other examples. Concerning twisted support members (e.g., 193), it should be noted that some embodiments have one more half-twist) (180° than what is shown in FIGS. 17-20 to help keep the support members from un-twisting. Other embodiments may have even more twists, or may have fewer twists, as other examples.

As shown in FIGS. 4-20, in some embodiments, the support members (e.g., 63, 143, or 193) have a support member diameter (e.g., 82, 162, or 182) and the support member diameter may be larger or substantially larger than the helix diameter (e.g., 81, 161, or 181), for instance. As used herein, “substantially larger” means larger in dimension by more than 25 percent of the smaller dimension (e.g., helix diameter 81, 161, or 181). In some embodiments, the support members are helical (e.g., support members 63 as shown in FIGS. 4-12), extend uninterrupted 360 degrees around the helix (e.g., support members 63 as shown in FIGS. 4-12), are located in a helical pattern around the helix (e.g., bends or support members 233 as shown in FIGS. 21-25), or are spaced at multiple locations around the helix (e.g., support members 143 or 193, which are spaced at three locations around the helix as shown in FIGS. 13-20), as further examples. In some embodiments, for example, the support members (e.g., 143 or 193) are spaced at multiple locations that are substantially equally spaced around the helix (e.g., as shown in FIGS. 13-20), are spaced at three locations around the helix (e.g., as shown), are located in three lines substantially equally spaced around the helix (e.g., as shown), or a combination thereof, or are spaced or located at more than three such location or in more than three such lines, as examples. In other embodiments, as other examples, the support members may be located in four, five, six, seven eight, nine, ten, twelve, sixteen, or more locations or lines, for example, spaced or substantially equally spaced around the helix. As used herein, “substantially equally spaced” means equally spaced to within plus or minus ten (10) percent, for example, when measured as angles with reference to a centerline or when measured as a distance along an arc or helix between the items.

In a number of embodiments, the helix (e.g., 64, 114, 144, or 194) has multiple turns and the support members (e.g., 63, 143, or 193) are located at regular numbers of turns along the helix (e.g., 64, 114, 144, or 194). FIGS. 4-20 illustrate examples. In some embodiments, the helix (e.g., 64, 114, 144, or 194) has multiple turns and the support members (e.g., 63, 143, or 193) or a group of (e.g., three) support members, are located more frequently than every 15 turns along the helix, more frequently than every 12 turns along the helix, more frequently than every ten (10) turns along the helix, or even more frequently than every eight (8) turns along the helix (e.g., 64, 114, 144, or 194), as examples. Further, in some embodiments, the helix (e.g., 64, 114, 144, or 194) has multiple turns and the support members (e.g., 63, 143, or 193), or a group thereof, are located less frequently than every three (3) turns along the helix, less frequently than every four (4) turns along the helix, less frequently than every five (5) turns along the helix, less frequently than every six (6) turns along the helix, less frequently than every eight (8) turns along the helix, or even less frequently than every ten (10) turns along the helix (e.g., 64, 114, 144, or 194), as examples. In specific embodiments, for instance, the helix (e.g., 64, 114, 144, or 194) has multiple turns and the support members (e.g., 63, 143, or 193, one or a group thereof) are located every seven (7) turns along the helix (e.g., FIGS. 4-12), every eight (8) turns along the helix (e.g., FIGS. 17-20), every nine (9) turns along the (e.g., FIGS. 13-16), or every twelve (12) turns along the helix, as examples. As used herein, unless stated otherwise, such numbers of turns are within an accuracy of plus or minus one quarter of a turn. In other embodiments, the support members (e.g., 63, 143, or 193) may be located every two, three, four, five, six, ten, eleven, thirteen, fourteen, or fifteen turns along the helix, as other examples.

Further, in embodiment 240 shown in FIGS. 21-25, the bends or support members 233 are located more frequently than every half turn along the modified helix 244. In other embodiments, support members may be located less frequently than every half turn along the modified helix, or may be located every ⅔, ¾, ⅞, 9/8, 5/4, 4/3, 5/3, 7/4, 9/4, 7/3, 8/3, 11/4, 13/4, 10/3, 11/3, 15/4, 17/4, 13/3, 14/3, 19/4, 21/4, 16/3, 17/3, 23/4, 25/4, 19/3, 21/3, 27/4, 29/4, 31/4, 33/4, 35/4, 37/4, 39/4, 41/4, 43/4, or 45/4 of a turn along the modified helix, as other examples. In some embodiments, the number of turns of the helix or modified helix between support members may vary, as another example.

In some embodiments (e.g., 60, 110, 140, and 190), the support members (e.g., 63, 143, or 193 shown in FIGS. 4 to 20)) are sized and configured to hold the helix (e.g., 64, 114, 144, or 194) substantially concentric with the heat exchanger or heat exchanger tube (e.g., 11, 12, 13, or 14). In addition, in embodiment 240 shown in FIGS. 21-25, the support members 233 are sized and configured to hold modified helix 244 substantially concentric with the heat exchanger tube (e.g., 11, 12, 13, or 14). As used herein, “substantially concentric with the heat exchanger tube” means concentric to within plus or minus ten (10) percent of the inside diameter (e.g., 41) of the heat exchanger tube (e.g., 11, 12, 13, or 14). In some embodiments, the support members (e.g., 63, 143, or 193) are sized and configured to hold the helix (e.g., 64, 114, 144, or 194) a certain (e.g., minimum) distance from the inside surface of the heat exchanger or of the heat exchanger tube (e.g., 11, 12, 13, or 14). Further, in various embodiments, the apparatus (e.g., 60, 110, 140, 190, or 240) or the support members (e.g., 63, 143, 193, or 233) may be sized and configured to have an interference fit with the heat exchanger (e.g., 15) or heat exchanger tube (e.g., 11, 12, 13, or 14, for instance, with inside diameter 41). This interference fit may hold, or help to hold, the apparatus (e.g., 60, 110, 140, 190, or 240) in place, for example, or may reduce movement of the apparatus and any resulting noise. In other embodiments, the apparatus (e.g., 60, 110, 140, 190, or 240) or the support members (e.g., 63, 143, 193, or 233) may be sized and configured to have a clearance fit with the heat exchanger or heat exchanger tube (e.g., 11, 12, 13, or 14, for instance, with inside diameter 41).

As mentioned, certain embodiments include an attachment member (e.g., 66, 116, 146, 196, or 246 shown in FIGS. 4-22 and 24-25), for instance, extending from the helix or modified helix (e.g., 64, 114, 144, 194, or 244) for attaching the apparatus (e.g., 60, 110, 140, 190, or 240), for example, to entrance end 111 of the heat exchanger (e.g., 15) or heat exchanger tube (e.g., 11, 12, 13, or 14). In some embodiments, the attachment member (e.g., 66, 116, 146, 196, or 246) may include the wire (e.g., 61, 101, 141, 191, or 241), or may consist entirely of the wire, for example. Further, as illustrated in FIGS. 13-20, in some embodiments, the attachment member (e.g., 146 or 196) may include a hook (e.g., 157 or 197), for instance, formed in an end of the wire (e.g., as shown) for attaching the apparatus (e.g., 140 or 190) to the heat exchanger (e.g., 15) or heat exchanger tube (e.g., 11, 12, 13, or 14). In other embodiments, as illustrated in FIGS. 4-12 and 21-25, the attachment member (e.g., 66, 116, or 246) may include a right angle bend (e.g., 77, 127, or 257), for instance, formed in an end of the wire (e.g., as shown) for attaching the apparatus (e.g., 60, 110, or 240) to the heat exchanger (e.g., 15) or heat exchanger tube (e.g., 11, 12, 13, or 14). As used herein, a hook (e.g., 157 or 197) has an angle that exceeds 100 degrees but that is less than 360 degrees. For example, a hook may have an angle of 135 degrees to 225 degrees, for instance, or may have an angle of about 180 degrees, for example. Also as used herein, a “right angle bend” (e.g., 77, 127, or 257) has an angle between 80 and 100 degrees. Other embodiments of angle bends may have a different angle, as other examples. In various embodiments a hook, right angle bend, or other angle bend in an attachment apparatus may have a radius of curvature that is less than, less than half of, less than one quarter of, or less than one eighth of, the radius of curvature of the helix (e.g., 64, 114, 144, 194) or modified helix (e.g., bend or support member 233), as examples.

In some embodiments (e.g., with or without a hook such as 157 or 197, or a right angle bend such as 77, 127, or 257) the attachment member may include a loop, for example, at the end of the wire, for instance, for attaching the apparatus to the heat exchanger (e.g., 15) or heat exchanger tube (e.g., 11, 12, 13, or 14), for example, at or near the burner (e.g., 115, 125, 135, or 145) or at the entrance end (e.g., 111), for instance. In some embodiments, the loop may have a loop diameter that is greater than the helix diameter (e.g., 81, 161, or 181), for example. In particular embodiments, such a loop diameter may be less than the outside diameter of the heat exchanger or heat exchanger tube (e.g., 11, 12, 13, or 14), prior to installation of the apparatus (e.g., NOx reduction apparatus) in the heat exchanger or heat exchanger tube (e.g., 11, 12, 13, or 14), and the loop may have or may form an interference fit with the heat exchanger or heat exchanger tube (e.g., when installed). In various embodiments, such a loop may extend for more than 180 degrees (e.g., more than half way around the heat exchanger tube), for less than 360 degrees (e.g., less than half way around the heat exchanger tube), or both, as examples.

In particular embodiments, the helix (e.g., 64 or 114 shown in FIGS. 4-12) may have a varying helix diameter (e.g., from diameter 81 to diameter 82 shown in FIG. 8) along the helix (e.g., along apparatus 60 or 110, excluding attachment members 66 and 116). In some embodiments, the helix (e.g., 64, 114, 144, or 194) may have a substantially uniform helix diameter (e.g., 81, 161, or 181) along the helix, for example, except for support members, such as 63, 143, or 193. Some embodiments may have a substantially uniform helix diameter (e.g., 81, 161, or 181) along one or more portions of the helix (e.g., 64, 114, 144, or 194) or contiguous groups of turns (e.g., 74 or 124). In some embodiments, the helix (e.g., 64, 114, 144, or 194) may have a substantially uniform helix diameter (e.g., 81, 161, or 181) along the helix (e.g., 64, 114, 144, or 194), in some embodiments, except for at or adjacent to the support members (e.g., 63). As used herein, a helix is said to have a “substantially uniform diameter” if the coils or turns (e.g., 74 or 124) of the helix (e.g., 64, 114, 144, or 194) have the same diameter to within plus or minus ten (10) percent of a mean diameter.

In various embodiments, the wire (e.g., 61, 101, 141, 191, or 241) may be positioned (e.g., all, mostly, or except for any support member or attachment member) away from the inside surface of the heat exchanger (e.g., 15) or heat exchanger tube (e.g., 11, 12, 13, or 14). In certain embodiments, for example, the helix diameter (e.g., 81, 161, or 181) is less than ¾ of the inside diameter (e.g., 41) of the heat exchanger tube (e.g., 11, 12, 13, or 14), less than ⅔ of the inside diameter (e.g., 41) of the heat exchanger tube, less than ⅗ of the inside diameter (e.g., 41) of the heat exchanger tube, or less than ½ of the inside diameter (e.g., 41) of the heat exchanger tube (e.g., 11, 12, 13, or 14), for instance. On the other hand, in some embodiments, the helix diameter (e.g., 81, 161, or 181) is greater than ½ of the inside diameter (e.g., 41) of the heat exchanger tube (e.g., 11, 12, 13, or 14), greater than ¼ of the inside diameter (e.g., 41) of the heat exchanger tube, greater than ⅓ of the inside diameter (e.g., 41) of the heat exchanger tube, greater than ⅜ of the inside diameter (e.g., 41) of the heat exchanger tube, or greater than 7/16 of the inside diameter (e.g., 41) of the heat exchanger tube (e.g., 11, 12, 13, or 14), as examples. In some specific embodiments, for instance, the helix diameter (e.g., 81, 161, or 181) is about ½ of the inside diameter (e.g., 41) of the heat exchanger tube (e.g., 11, 12, 13, or 14). As used herein, unless stated otherwise, “about” means plus or minus ten (10) percent. In particular embodiments, the helix diameter (e.g., 81, 161, or 181) may be less than one (1) inch, less than ⅞ inch, less than ¾ inch, less than 11/16 inch, or less than ⅝ inch, as examples. Further, in the same or different embodiments, the helix diameter (e.g., 81, 161, or 181) may be greater than 7/16 inch, greater than one half (½) inch, greater than 9/16 inch, or greater than ⅝ inch, as examples. Examples of certain helix diameters (e.g., 81, 161, or 181) include 0.706 inches outside diameter and 0.625 inches inside diameter, as examples.

In some embodiments, the wire (e.g., 61, 101, 141, 191, or 241) may have a length for example, from the attachment member (e.g., 66, 116, 146, 196, or 246), through the support members (e.g., 63, 143, 193, or 233), and through the coil that is the farthest from the attachment member (e.g., coil 69, 119, 159, 199 or 259). In a number of embodiments, the wire (e.g., 61, 101, 141, 191, or 241) may have a substantially constant cross section along the length of the wire. As used herein, “substantially constant” means constant to within plus or minus ten (10) percent in any major dimension. In particular embodiments, the wire (e.g., 61, 101, 141, 191, or 241) may have a circular cross section, and in various embodiments, the wire may have a hollow cross section or may be solid, as examples.

In certain embodiments, the wire (e.g., 61, 101, 141, 191, or 241) may be Nichrome wire, for example, or stainless steel wire. In some embodiments, other materials may be used that are suitable to withstand the temperatures present. As used herein, Nichrome wire includes nickel and chromium as its two largest ingredients. Nichrome wire may include nickel as its largest single alloy ingredient, for example, or may even be mostly (e.g., more than half) nickel for instance. In some embodiments, Nichrome wire may include at least 70 percent nickel and at least 15 percent chromium, for example. In some embodiments, Nichrome wire may include at least 75 percent nickel and at least 17 percent chromium, for another example. In certain embodiments, Nichrome wire may include at least 79 percent nickel and at least 19 percent chromium, for instance. Further, in particular embodiments, Nichrome wire may be about (e.g., plus or minus ½ of 1 percent) 80 percent nickel and 20 percent chromium, for example. In some embodiments, porcupine wire or electrical resistance heating element wire may be used, for instance, which may be selected to adequately resist oxidation in the high-temperature environment present in a heat exchanger (e.g., 15) or heat exchanger tubes (e.g., 11, 12, 13, 14, or a combination thereof).

In some embodiments, the helix or modified helix (e.g., 64, 114, 144, 194 or 233) may have an interior volume (e.g., 80, 160, 180, or 220) shown in FIGS. 8, 16, 18, and 22), and the interior volume may be devoid of structural members (e.g., devoid of sheet metal support 33 shown in FIG. 3). In some embodiments, the interior volume (e.g., 80, 160, 180, or 220) of the helix (e.g., 64, 114, 144, or 194) may be empty, for example. See, for example, FIGS. 4-25. As used herein, an interior volume (e.g., 80, 160, 180, or 220) is considered to be empty even if it contains a gas such as air, flame, or gaseous products of combustion, as examples.

Certain embodiments are, or are part of, a device for obtaining energy by burning a fuel. A furnace (e.g., furnace 10 shown in FIG. 1) is an example of such a device. Some such devices include, for example, (among other things) a location for burning the fuel (e.g., burner 115, 125, 135, 145, heat exchanger 15 or heat exchanger tubes 11, 12, 13, or 14, or a combination thereof), a mechanism for harnessing the energy from burning the fuel (e.g., heat exchanger 15), an enclosed passageway for containing products of combustion from the burning of the fuel (e.g., heat exchanger tube 11, 12, 13, or 14), and a wire (e.g., wire 61, 101, 141, 191, or 241 or embodiments 60, 110, 140, 190, or 240 shown in FIGS. 4-25) within the enclosed passageway. In various embodiments, the wire (e.g., 61, 101, 141, 191, or 241) may have multiple bends or various combinations of other features described herein, as examples. Other embodiments, instead of the wire (or in addition thereto) may have multiple fins that extend into the enclosed passageway, as another example. Some embodiments are, or are part of, a device specifically for obtaining heat by burning a fuel. In some such embodiments, the device may include, for example, (e.g., among other things) a fuel delivery system (e.g., which may include burner 115, 125, 135, 145, or a combination thereof) an air intake system, a heat exchanger (e.g., 15) or heat exchanger tube (e.g., 11, 12, 13, or 14) where the fuel is burned in the air, a wire (e.g., wire 61, 101, 141, 191, or 241, such as embodiments 60, 110, 140, 190, or 240 shown in FIGS. 4-25) within the heat exchanger or heat exchanger tube, or a combination thereof. Again, in various embodiments, the wire (e.g., 61, 101, 141, 191, or 241) may have various combinations of other features described herein, as examples. And again, other embodiments, instead of the wire (or in addition thereto) may have multiple fins that extend into the enclosed passageway.

Further embodiments are, or are part of, a device for changing and controlling temperature of an occupied space (e.g., 2606) or for heating an occupied space (e.g., a furnace, such as furnace 10 shown in FIGS. 1 and 26 or an HVAC unit, such as HVAC unit 262 shown in FIG. 26), for example. In some such embodiments, the device may include, for example, a burner (e.g., 115, 125, 135, 145, or a combination thereof), a heat exchanger (e.g., 15) or heat exchanger tube where combustion of a fuel takes place (e.g., 11, 12, 13, 14, or a combination thereof), and a wire (e.g., wire 61, 101, 141, 191, or 241, or embodiments 60, 110, 140, 190, or 240 shown in FIGS. 4-25) within the heat exchanger tube (e.g., 11, 12, 13, 14, or a combination thereof). Various embodiments may further include a heat exchanger (e.g., 15) for transferring heat from a first fluid (e.g., products of combustion moved by fan 17) to a second fluid (e.g., air to be delivered through heat exchanger 15 and then to the space by fan 16).

Other embodiments are devices for obtaining energy by burning a fuel that include, for example, a location for burning the fuel (e.g., burners 115, 125, 135, 145, or a combination thereof), a mechanism for harnessing the energy from burning the fuel (e.g., heat exchanger similar to heat exchanger 15), an enclosed passageway for containing products of combustion from the burning of the fuel (e.g., similar to heat exchanger tubes, 11, 12, 13, 14, or a combination thereof), and multiple fins that extend into the enclosed passageway (e.g., into the heat exchanger tube). In some such embodiments, the enclosed passageway or heat exchanger tube (e.g., at least the portion where combustion takes place) is ceramic, the multiple fins are ceramic, the enclosed passageway or heat exchanger tube (e.g., or a portion thereof) and the multiple fins are one piece of material, or a combination thereof, as examples. Ceramic fins may need to be fairly thin, in some embodiments. In a number of embodiments, the fins are used to enhance combustion or to reduce the production of pollutants, such as for NOx reduction, for example. In various embodiments, the device may be a furnace (e.g., similar to furnace 10), an HVAC unit (e.g., similar to HVAC unit 262 that may include direct expansion air conditioning 263 and a furnace 10), a building (e.g., 260) having an HVAC system (e.g., similar to 261) or a furnace, or the like, as examples.

In some embodiments, the enclosed passageway or heat exchanger tube (e.g., similar to 11, 12, 13, 14, or a combination thereof, or portion thereof) may have at least one wall and the multiple fins may be connected to the wall. Further, in some embodiments, the multiple fins may extend radially inward from the wall, may each be substantially perpendicular to the wall, may each have a substantially identical dimension in a direction perpendicular to the wall, or a combination thereof, as examples. As used herein, “substantially perpendicular” means perpendicular (e.g., to a line tangent to the wall at the point of intersection) to within plus or minus ten (10) degrees. In addition, as used herein, “substantially identical” means identical (e.g., in dimension or angle) to within plus or minus ten (10) percent. In some embodiments, the enclosed passageway, heat exchanger, or heat exchanger tube (e.g., similar to 11, 12, 13, 14, or a combination thereof) may have a center, and a distance from the wall to the center, and the fins may extend more than a third of the distance from the wall toward the center, less than two thirds of the distance from the wall toward the center, or about half of the distance from the wall toward the center, as examples. On the other hand, in some embodiments, the fins may extend more than half of the distance from the wall toward the center.

In some embodiments, the multiple fins may include at least five fins, at least six fins, at least eight fins, at least ten fins, or at least twelve fins, as examples. Further, in some embodiments, the multiple fins may specifically consist of twelve fins. Further still, in some embodiments, the multiple fins may all have substantially identical dimensions. In some embodiments, multiple of the fins may be substantially parallel with the centerline, or in certain embodiments, all of the fins may be parallel with the centerline. As used herein, “substantially parallel” means parallel to within 10 degrees, and “parallel” means parallel to within 5 degrees. Moreover, in some embodiments, multiple of the fins may be substantially coplanar with the centerline. As used herein, “substantially coplanar” means coplanar to within 10 degrees, and “coplanar” means coplanar to within 5 degrees. In some embodiments, all of the fins may be coplanar with the centerline, as another example. On the other hand, in some embodiments, multiple of the fins may wind helically about the centerline. Embodiments that include a ceramic material may include or consist essentially of a magnesium iron aluminum cyclosilicate, for example, such as Cordierite, for instance. In other embodiments, other ceramic materials having suitable properties may be used.

In some embodiments, a wire configuration (e.g., porcupine element) may be employed for NOx reduction (e.g., in a furnace, heat exchanger, or heat exchanger tube, such as 11, 12, 13, 14, or a combination thereof) that has been used in electric heater elements to heat an occupied space (e.g., 2606) or air delivered thereto. Besides the different embodiments of apparatuses (e.g., 60, 110, 140, 190, or 240) described above (or including at least some embodiments thereof), in some embodiments, the apparatus (e.g., 60, 110, 140, 190, or 240) may include an elongated body or wire (e.g., 61, 101, 141, 191, or 241) having a length, which may be shaped to form a modified helix (e.g., 64, 114, 144, or 194 plus support members 63, 143, or 193, or modified helix 244), for example. In some embodiments, the wire (e.g., 241 shown in FIGS. 21-25) may include multiple bends (e.g., 233) along the length of the wire (e.g., 241). In a number of embodiments, each bend (e.g., 233) may have a substantially identical radius, a substantially identical angle, or both, for instance. In some embodiments, the angle of each bend (e.g., 233) in the wire (e.g., 241) may be close to, but not equal to 180 degrees, for example. For instance, in particular embodiments, the angle of each bend (e.g., 233) in the wire (e.g., 241) may differ from 180 degrees by at least 5, 10, 15, 20, 25, 30, 35, 40, or 45 degrees, as examples. In some embodiments, the angle of each bend (e.g., 233) in the wire (e.g., 241) may be greater than 135 degrees, less than 180 degrees, or both, as examples. In certain embodiments, the angle of each bend (e.g., 233) in the wire (e.g., 241) may be greater than 150 degrees, less than 175 degrees, or both, as other examples.

In some embodiments, adjacent bends (e.g., 233) along the length of the wire (e.g., 241) may be separated by straight sections (e.g., 231) of the wire, for example. In some embodiments, each straight section (e.g., 231) may have a substantially identical dimension along the length of the wire (e.g., 241), for instance. FIGS. 21-25 illustrate an example of such an apparatus (e.g., 240). In FIG. 23, for instance, bends 2331 and 2332 are adjacent to each other and are separated by straight section 2311. Similarly, bends 2332 and 2333 are adjacent to each other and are separated by straight section 2312. In other embodiments, a shape other than straight may be substituted for the straight section of wire (e.g., 231) shown and described. For example, in some embodiments, a curved section of wire with a significantly larger radius of curvature may be used, or that curves in the opposite direction (e.g., compared to bends 233). In other embodiments, a section of wire having a sinusoidal shape or a helical shape (e.g., a helix having an axis where straight sections 231 are shown) may be substituted for straight sections 231, as other examples.

In various embodiments, the wire (e.g., 61, 101, 141, 191, or 241) may have a substantially constant cross section along the length of the wire, a substantially circular cross section, a solid cross section, a hollow cross section, or a combination thereof (e.g., to the extent possible), for example. Further, in some embodiments, the radius of each bend (e.g., 233) is substantially constant along the bend. In particular embodiments, each bend (e.g., 233) may have a mid point (e.g., 237 shown in FIG. 23), and each bend (e.g., 233) may be substantially symmetrical about the midpoint (e.g., 237) of the bend, as another example. As used herein, “substantially symmetrical” means symmetrical to within ten (10) percent of any major dimension. Further, in some embodiments, each bend (e.g., 233) has a first half (e.g., 238 shown in FIG. 23) and a second half (e.g., 239) and the angle of each bend (e.g., 233) and the dimension along the length of the wire (e.g., 241) of each straight section (e.g., 231) are selected so that in the modified helix (e.g., 244), a first half (e.g., 238) of a first bend (e.g., 2331) crosses a second half (e.g., 239) of a third bend (e.g., 2333). In this description, the first and third bends (e.g., 2331 and 2333) are numbered starting on an end (e.g., at attachment member 246) of the wire (e.g., 241). An example of such an embodiment is shown in FIGS. 21-25.

In some embodiments, the wire (e.g., 61, 101, 141, 191, or 241) may include Nichrome, or the apparatus (e.g., 60, 110, 140, 190, or 240) may consist essentially of Nichrome wire, as examples, and, in some embodiments, may be devoid of other structure (e.g., sheet metal support 33 shown in FIG. 3) inside (e.g., within interior volume 80, 160, 180, or 220) the apparatus (e.g., 60, 110, 140, 190, or 240). In particular embodiments, a furnace (e.g., 10 shown in FIGS. 1 and 26) containing the wire (e.g., 61, 101, 141, 191, or 241) or apparatus (e.g., 60, 110, 140, 190, or 240) may include a tube (e.g., heat exchanger tube 11, 12, 13, or 14) surrounding the wire (e.g., 61, 101, 141, 191, or 241), for instance, shaped to form the modified helix. In a number of embodiments, a furnace (e.g., 10) containing the wire (e.g., 61, 101, 141, 191, or 241) may include a burner mechanism (e.g., 115, 125, 135, 145, or a combination thereof) for burning a fuel for obtaining energy (e.g., heat). Further, in some embodiments, a furnace (e.g., 10) containing the wire (e.g., 61, 101, 141, 191, or 241) may include at least one fan (e.g., 16, 17, or both, for instance, for moving air, products of combustion, or both). Moreover, a number of embodiments of a furnace (e.g., 10) containing the wire (e.g., 61, 101, 141, 191, or 241) may include a heat exchanger (e.g., 15) for transferring heat from a first fluid (e.g., the products of combustion) to a second fluid (e.g., air to be delivered to the space, such as indoor air or a mixture of indoor and outdoor air). Various embodiments may include a combination of such features, as examples. Further, in some embodiments, an HVAC unit (e.g., 262 shown in FIG. 26) may include such a furnace (e.g., 10), and may also include an air conditioning system (e.g., 263), for example.

Besides equipment such as pollution-reduction apparatuses and devices (e.g., 60, 110, 140, 190, or 240), furnaces (e.g., 10), HVAC units (e.g., 262), HVAC systems (e.g., 261), and buildings (e.g., 260), various embodiments include a number of methods, including methods of making, obtaining, providing, and using such equipment, apparatuses, or devices. In a number of embodiments, different methods may include, in various sequences, certain acts. Various examples are methods of making or implementing certain NOx-reducing apparatuses (e.g., 60, 110, 140, 190, or 240) for use in a heat exchanger (e.g., 15) or heat exchanger tube (e.g., 11, 12, 13, 14, or a combination thereof), for example.

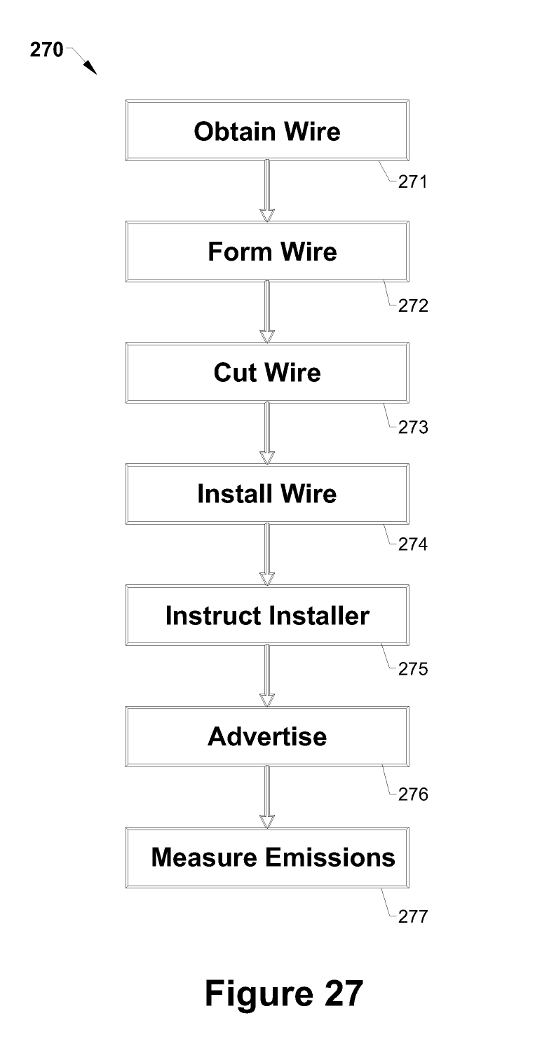

In some embodiments, various methods (e.g., method 270 shown in FIG. 27) may include at least the acts of obtaining wire (e.g., act 271) and forming the wire (e.g., act 272). In the embodiment illustrated, method 270 also includes act 273 of cutting the wire. Wire (e.g., 61, 101, 141, 191, or 241) may be obtained (e.g., in act 271), for example, by purchasing the wire, for instance, from a supplier or a distributor, as examples. In some embodiments, wire may be obtained (e.g., in act 271), for example, by making the wire, for instance, by drawing the wire. In some embodiments, the act of obtaining wire (e.g., act 271) may include obtaining Nichrome wire, for example. Wire (e.g., 61, 101, 141, 191, or 241) may be formed (e.g., in act 272) by making various bends in the wire, or by winding the wire, as examples.

In some embodiments, forming the wire (e.g., act 272) may include forming multiple bights (e.g., support members 143 or main bends 167) in the wire (e.g., 61, 101, 141, 191, or 241), winding the wire to form a helix (e.g., 64, 114, 144, or 194) having a helix diameter (e.g., 81, 161, or 181), or both, as examples. In some embodiments, the wire (e.g., 141) may be formed (e.g., in act 272), for example, so that the bights project outward from the helix (e.g., 144) beyond the helix diameter (e.g., 161). In some such embodiments, the act of forming the wire (e.g., act 272) may include winding the wire around a mandrel, for example. In certain embodiments, an act of forming the wire (e.g., act 272) may include an act of twisting the bights in the wire (e.g., to form support members 193 shown in FIGS. 17-20), and in some embodiments, the bights in the wire, or groups of such bights, may be formed at regular intervals along the wire, or following a pattern of intervals along the wire, for instance.

In some embodiments (e.g., 60 and 110 shown in FIGS. 4-12), an act of forming the wire (e.g., act 272) may include winding the wire (e.g., 61) to form a modified helix having smaller helical turns (e.g., 54 or 104) and larger (e.g., helical) turns (e.g., 53 or 103), for instance, wherein the larger turns are spaced between groups of smaller helical turns, wherein the smaller helical turns and the larger turns have a substantially common centerline, or both, (e.g., as shown in FIGS. 4-12), as examples. Moreover, in some embodiments, the act of forming the wire (e.g., act 272) may include an act of forming an attachment member (e.g., 66, 116, 146, 196, or 246) in the wire (e.g., 61, 101, 141, 191, or 241). In some embodiments, the act of forming an attachment member (e.g., 66, 116, 146, 196, or 246) in the wire may include forming a straight section of wire (e.g., 55, 106, 156, 206, or 256) forming a hook (e.g., 157 or 197) in the wire, forming a loop in the wire, or a combination thereof, as examples. Various embodiments further include an act of installing the wire (e.g., act 274), for example, in the heat exchanger tube (e.g., 11, 12, 13, 14, or a combination thereof), for instance, where combustion takes place. In some embodiments, the act of installing the wire (e.g., act 274), may include installing the wire in a heat exchanger (e.g., 15), in a furnace (e.g., 10), or both, for instance.

Further, certain embodiments (e.g., of making or implementing a NOx reducing apparatus) may include an act of instructing an installer (e.g., act 275). An installer (e.g., of furnace 10, HVAC unit 262, or HVAC system 261) may be instructed (e.g., in act 275) with written instructions, drawings, or both, provided with the product (e.g., furnace 10 or HVAC unit 262) or on packaging, through a website, by e-mail, through advertising, through sales information, printed in a manual, or the like, as examples. In some embodiments, instructions may be provided (e.g., in act 275) verbally, using pictures or video, or in person, as other examples. In some embodiments, the act of instructing an installer (e.g., act 275) includes instructing that the furnace (e.g., 10, for instance, containing the wire, for instance, 61, 101, 141, 191, or 241) can burn natural gas, instructing the installer that the furnace can burn LP gas, or both. In some embodiments, such an act (e.g., 275) may be accomplished, for example, without instructing the installer to omit the wire (e.g., wire 61, 101, 141, 191, or 241 or apparatus 60, 110, 140, 190, or 240) for use with LP gas.

Various embodiments may also (or instead) include an act of advertising (e.g., act 276), for instance, that the wire (e.g., 61, 101, 141, 191, or 241) reduces NOx, that an apparatus (e.g., 60, 110, 140, 190, or 240) including the wire can burn natural gas and can also burn LP gas, or a combination thereof, as examples. Advertising (e.g., in act 276) may be performed through a website, by e-mail, through sales literature, by mail, through mass media, through an audio or video transmission (or both) or recording, through sales people, through distributors, on product packaging, or the like, as examples. Further, some embodiments include an act of measuring emissions (e.g., act 277), such as NOx production from an apparatus (e.g., 60, 110, 140, 190, or 240) or a furnace (e.g., 10), for instance, that includes the wire (e.g., 61, 101, 141, 191, or 241), for example, to verify that the NOx production does not exceed a regulatory standard. In different embodiments, some or all HVAC units (e.g., 262) or furnaces (e.g., 10) may be tested (e.g., in act 277). In some cases, HVAC units (e.g., 262) or furnaces (e.g., 10) may be tested after being in service for a significant period of time or at various periods of time, as examples. In different embodiments, wires (e.g., 61, 101, 141, 191, or 241) or apparatuses (e.g., formed in act 272) may be sold, or units (e.g., furnace 10 or HVAC unit 262) having such apparatuses or wires may be sold, for example, to the public, through distributors, to building (e.g., 260) owners, to contractors, or the like, as examples. Sales may be made by advertising (e.g., in act 276) and taking orders, as examples.

Various examples of embodiments, for instance, are methods of reducing NOx emissions from a furnace (e.g., 10), the furnace having at least one heat exchanger (e.g., 15) or heat exchanger tube (e.g., 11, 12, 13, 14, or a combination thereof) and at least one burner mechanism (e.g., 115, 125, 135, 145, or a combination thereof) configured, for example, to form a flame within the heat exchanger or heat exchanger tube. In these examples, the flame has dimensions and a temperature, and the method may include an act of adding, within the heat exchanger (e.g., 15) or heat exchanger tube (e.g., 11, 12, 13, 14, or a combination thereof), at least one baffle, for instance. In some embodiments, the baffle is made of a solid material selected to withstand the temperature of the flame, for example, and in some embodiments, the baffle is shaped or selected to have dimensions, and is positioned, so that the baffle fits within the dimensions of the flame, such that, when the furnace is in operation, any deleterious soot that forms on the baffle is burned off, for instance, even if LP gas is burned in the furnace (e.g., 10).

In some such embodiments, the act of adding or installing, within the heat exchanger (e.g., 15) or heat exchanger tube (e.g., 11, 12, 13, 14, or a combination thereof), at least one baffle, may include adding at least one wire (e.g., 61, 101, 141, 191, or 241) within the heat exchanger tube (e.g., where combustion takes place), for instance (e.g., act 274). In some embodiments, the wire may have multiple bends (e.g., 233), may be shaped to form a modified helix (e.g., 244), or both. Further, in some embodiments, the multiple bends (e.g., 233) in the wire (e.g., 241) each have a substantially identical radius, each have a substantially identical angle, each have an angle that is greater than 135 degrees, each have an angle that is greater than 150 degrees, each have an angle that less than 180 degrees, each have an angle that less than 175 degrees, or a combination thereof, as example. Moreover, in some embodiments, the act (e.g., act 274) of adding, within the heat exchanger tube (e.g., 11, 12, 13, 14, or a combination thereof), at least one baffle, may include adding the at least one wire (e.g., 241) wherein adjacent bends (e.g., 233) along the wire are separated by straight sections (e.g., 231) of the wire. In some embodiments, each straight section (e.g., 231) may have a substantially identical length, each bend (e.g., 233) may have a first half (e.g., 238) and a second half (e.g., 239), the angle of each bend (e.g., 233) and the length of each straight section (e.g., 231) may be selected so that the first half (e.g., 238) of a first bend (e.g., 2331) crosses the second half (e.g., 239) of a third bend (e.g., 2333) (i.e., wherein the first and third bends are numbered starting on an end of the wire, such as the end having attachment member 246), or a combination thereof, as examples (e.g., as shown in FIGS. 21-25). In some embodiments, each bend (e.g., 233) may have a substantially constant radius along the bend, each bend may have a mid point (e.g., 237) and each bend may be substantially symmetrical about the midpoint of the bend, or a combination thereof. In some embodiments, the act (e.g., 274) of adding, within the heat exchanger tube (e.g., 11, 12, 13, 14, or a combination thereof), at least one baffle (e.g., act 274), may include adding at least one wire (e.g., 61, 101, 141, 191, or 241) that consists essentially of Nichrome wire, for instance.

In some embodiments, the act of adding, within the heat exchanger (e.g., similar to 15) or heat exchanger tube (e.g., similar to 11, 12, 13, 14, or a combination thereof), at least one baffle (e.g., similar to act 274), may include adding (e.g., where combustion takes place) multiple fins that extend into the heat exchanger tube, as another example. In certain embodiments, the act of adding, within the heat exchanger tube, at least one baffle, may include adding at least one baffle that includes ceramic or that consists essentially of ceramic, as examples. In some embodiments, the act of adding, within the heat exchanger tube, at least one baffle, may include adding at least one baffle that is part of a common piece of material as at least a portion of the heat exchanger tube, adding at least one baffle that is connected to the wall of the heat exchanger tube, adding at least one baffle that extends radially inward from the wall, adding multiple baffles that are each substantially perpendicular to the wall, or a combination thereof, as examples.

Further, some embodiments may include acts of adding multiple baffles that each have a substantially identical overall dimension in a direction perpendicular to the wall, adding multiple baffles that each extend more than a third of the distance from the wall toward the center, adding multiple baffles that each extend less than two thirds of the distance from the wall toward the center, adding multiple baffles that extend about half of the distance from the wall toward the center, or a combination thereof. Furthermore, in some embodiments, the heat exchanger tube (e.g., similar to 11, 12, 13, 14, or a combination thereof) may have at least one wall, a center, and a distance from the wall to the center, and the act of adding, within the heat exchanger tube, at least one baffle (e.g., similar to act 274), may include adding multiple baffles that extend more than half of the distance from the wall toward the center. In some embodiments, the act of adding, within the heat exchanger tube, at least one baffle, may include adding at least five fins, adding at least six fins, adding at least eight fins, adding at least ten fins, adding at least twelve fins, or adding precisely twelve fins, as examples. Further, in some embodiments, the act of adding, within the heat exchanger tube, at least one baffle, may include adding multiple baffles that all have substantially identical dimensions, forming the baffle(s) by extrusion, adding at least one baffle that includes a ceramic material, adding at least one baffle consisting essentially of a ceramic material (e.g., Cordierite), or a combination thereof, as further examples. In some embodiments, the baffles or fins may be extruded, for example.

In some embodiments, manufacture of the apparatus (e.g., 60, 110, 140, 190, or 240) or wire (e.g., 61, 101, 141, 191, or 241) may be automated in whole or in part (e.g., in acts 272 and 273). In some embodiments, for example, a spring lathe coiler machine may be used to make wire NOx inserts, for instance (e.g., in act 272 of method 270). An example of such a machine is a Fortuna Federn (Austria) Machine handled by Phoenix Machinery, Des Plaines, Ill., for instance. Various embodiments may include or use a machine similar to this one, for example, which may further include with an attachment to create a bight and, in some embodiments, twist it (e.g., to make the embodiments shown in FIGS. 13-20). In certain embodiments, such an attachment may be located between a mandrel and a guide/cut-off tool (e.g., to perform act 273), for example. In particular embodiments, certain acts in a process may include, for example (e.g., for the embodiment shown in FIGS. 17-20):

1) Feeding the wire (e.g., 191) and clamping it to where a short length extends beyond the mandrel. (In some embodiments, this extension could become an additional spacer/leg, less twisted-bight, in some embodiments.)

2) The machine makes 2 turns) (720° and stops.

3) The bight-n-twist tool extends and makes the first spacer/leg (e.g., support member 193). (In some embodiments, the lathe and feed would track the material usage for creating the bight.)

4) The bight-n-twist tool retracts clear of the spacer/leg (e.g., support member 193).

5) The machine makes a ⅓ turn) (120° and stops.

6) The bight-n-twist tool extends and makes a second spacer/leg (e.g., support member 193). (In a number of embodiments, the lathe and feed would track the material usage for creating the bight.)

7) The bight-n-twist tool retracts clear of the spacer/leg (e.g., support member 193).

8) The machine makes a ⅓ turn)(120° and stops.

9) The bight-n-twist tool extends and makes the third spacer/leg (e.g., support member 193). (In some embodiments, the lathe and feed tracks the material usage for creating the bight.)

10) The bight-n-twist tool retracts clear of the spacer/leg (e.g., support member 193). (In some embodiments, this completes the end set of spacer/legs.)

11) The machine makes 7 turns) (2,520° and stops (e.g., forming a section of helix 194).

12) Steps 3 through 7 are then repeated.

13) Steps 11 and 12 are repeated 3 more times.

14) The machine makes 2⅓ turns) (780° and stops.

15) The mandrel retracts out of the bight.

16) A length of material is fed which will become the extend hook or attachment mechanism (e.g., attachment member 196 with hook 197).

17) The part is then cut free (e.g., in act 273) with the cut-off tool. The part (e.g., apparatus or embodiment 190) is complete except for the extended, for instance, 4″ hook (e.g., attachment member 196 with hook 197).

In some embodiments, the extended 4″ hook (e.g., attachment member 196 with hook 197), for example, is then formed in a separate operation which, in different embodiments, may be either automated or hand fed. In some embodiments, this separate operation may share a common base and combined controls with the spring lathe coiler machine, for example.

The “Double-Helix” or “Compound-Helix” NOx insert embodiments (e.g., 60 and 110) shown in FIGS. 4-12 may be more durable (when fired) than other embodiments (e.g., shown in FIGS. 13-25) because of the larger softer radii in making the transitions form the inner helix (e.g., 64 or 114) to the spacer feature or support members (e.g., 63). The embodiments shown in FIGS. 4-12 may also be quieter than other embodiments, for example. The embodiments shown in FIGS. 4-12 may also be more conducive to being made (e.g., in act 272) on standard wire forming equipment than other embodiments, for example, without the need for custom-made adaptors or other machine modifications. In some embodiments, standard (e.g., high speed) machines may out produce custom equipped lathe-type machines which may be used to make twisted leg/spacer embodiments (e.g., shown in FIGS. 13-20). In some embodiments, the process (e.g., for the embodiment shown in FIGS. 4-12) may be like making bed springs, for example, except with the parting tool cycling less often.

Various embodiments include various combinations of the acts, structure, components, and features described herein or shown in the drawings. Moreover, certain procedures may include acts such as obtaining or providing various components described herein, obtaining or providing components that perform functions described herein, advertising or selling products that perform functions described herein, or that contain structure or instructions to perform functions described herein, for instance, through distributors, dealers, or over the Internet, as examples. The invention also contemplates various means for accomplishing the various functions described herein or that are apparent from the structure and acts described.

What is claimed is:

1. An apparatus for reducing NOx production in a heat exchanger in which combustion takes place and through which products of combustion pass, the apparatus comprising:
a wire formed into a helix having a helix diameter; and
multiple support members extending outside of the helix diameter to hold the helix away from the heat exchanger, wherein the support members comprise the wire.

2. The apparatus of claim 1 wherein the support members consist entirely of the wire.

3. The apparatus of claim 1 wherein the support members have a support member diameter and the support member diameter is substantially larger than the helix diameter.

4. The apparatus of claim 1 wherein the support members are helical.

5. The apparatus of claim 1 wherein the helix has a varying helix diameter along the helix.

6. The apparatus of claim 1 wherein the helix has a substantially uniform helix diameter along the helix.

7. The apparatus of claim 1 wherein the support members comprise bights in the wire.

8. The apparatus of claim 1 wherein the support members comprise twists in the wire.

9. The apparatus of claim 1 wherein the support members are spaced at multiple locations around the helix.

10. The apparatus of claim 1 wherein the support members are spaced at multiple locations substantially equally spaced around the helix.

11. The apparatus of claim 1 further comprising an attachment member extending from the helix for attaching the apparatus.

12. The apparatus of claim 11 wherein the attachment member comprises the wire.

13. The apparatus of claim 12 wherein the attachment member consists entirely of the wire.

14. The apparatus of claim 1 wherein the wire is Nichrome wire.

15. The apparatus of claim 1 wherein the support members are sized and configured to hold the helix substantially concentric with a heat exchanger tube, wherein the helix has an interior volume, and the interior volume is empty.

16. A furnace comprising the apparatus of claim 1.

17. A building comprising the furnace of claim 16.

18. An apparatus for reducing NOx production in a heat exchanger in which combustion takes place and through which products of combustion pass, the apparatus comprising a wire formed into a modified helix having smaller helical turns and larger turns, wherein the larger turns are spaced between groups of smaller helical turns such that the larger turns substantially center the smaller helical turns in at least a portion of the heat exchanger when the apparatus is installed in the heat exchanger.

19. The apparatus of claim 18 wherein the smaller helical turns and the larger turns have a common centerline.

20. The apparatus of claim 18 wherein the wire comprises Nichrome.

21. A furnace comprising multiple of the apparatus of claim 18 wherein the furnace comprises a heat exchanger comprising multiple heat exchanger tubes in which combustion takes place and through which products of combustion pass, each heat exchanger tube comprising at least one said apparatus, wherein for each apparatus and for each heat exchanger tube, the larger turns substantially center the smaller helical turns in the heat exchanger tube when the apparatus is installed in the heat exchanger tube.

22. An HVAC unit comprising the furnace of claim 21 and also comprising an air conditioning system.

23. A furnace comprising at least one heat exchanger in which combustion takes place and through which products of combustion pass, and a NOx-reducing apparatus within the heat exchanger, the apparatus comprising an elongated wire having a length, wherein the wire is shaped to form a modified helix, wherein the wire comprises multiple bends along the length of the wire, each bend having a substantially identical radius and having a substantially identical angle, wherein the angle of each bend in the wire is less than 180 degrees, wherein adjacent said bends along the length of the wire are separated by straight sections of the wire, and wherein each straight section has a substantially identical dimension along the length of the wire.

24. A method of making a NOx-reducing apparatus for use in a heat exchanger in which combustion takes place and through which products of combustion pass, the method comprising at least the acts of:
obtaining wire;
winding the wire to form a modified helix having smaller helical turns and larger turns, wherein the larger turns are spaced between groups of smaller helical turns, wherein the smaller helical turns and the larger turns have a substantially common centerline; and
cutting the wire.

25. The method of claim 24 further comprising an act of installing the wire in the heat exchanger.

26. The method of claim 24 further comprising an act of instructing a furnace installer that a furnace comprising the wire can burn natural gas and instructing the furnace installer that the furnace comprising the wire can burn LP gas, without instructing the furnace installer to omit the wire for use with LP gas.

27. The method of claim 24 further comprising an act of advertising that an apparatus comprising the wire can burn natural gas and that an apparatus comprising the wire can burn LP gas.
